(19) United States
(12) Patent Application Publication
(10) Pub. No.: US 2005/0086621 A1
(43) Pub. Date: Apr. 21, 2005

(54) Method for processing design data of semiconductor integrated circuit

(75) Inventors: Yoichi Matsumura, Takatsuki (JP); Takako Ohashi, Otsu (JP); Katsuya Fujimura, Kameoka (JP); Chihiro Itoh, Nagaokakyo (JP); Hiroki Taniguchi, Kyoto (JP)

Correspondence Address: McDermott, Will & Emery, 600 13th Street, N.W., Washington, DC, 20005-3096, US

(73) Assignee: MATSUSHITA ELECTRIC INDUSTRIAL CO., LTD.

(21) Appl. No.: 10/895,821

(22) Filed: Jul. 22, 2004

(30) Foreign Application Priority Data
Oct. 16, 2003 (JP) 2003-356678

(51) Int. Cl. G06F 9/455; G06F 9/45

(52) U.S. Cl. 716/6; 716/11

(57) ABSTRACT

A circuit from which a buffer and an inverter are removed without changing logic is displayed. Such a circuit is obtained by a first or a second method. With the first method, all buffers which do not change logic and, when a clock path is divided at a branch point of wiring, all pairs of inverters located on each divided clock path are removed from the clock circuit. With the second method, a logic element located on a plurality of clock paths is copied and added to the clock circuit, all buffers which do not change logic and all pairs of inverters located between logic elements other than the above buffers are removed, and redundant partial circuits, if any, realizing the same logic and being located on a plurality of clock paths are removed. Thus, the clock circuit can be displayed so as to facilitate a designer's understanding of logic.

### BACKGROUND OF THE INVENTION

1. Field of the Invention

The present invention relates to a processing method of design data of a semiconductor integrated circuit, more particularly, relates to a processing method of design data of a clock circuit, etc., included in a semiconductor integrated circuit.

2. Description of the Background Art

Many semiconductor integrated circuits having a logic circuit operate in synchronization with a clock signal supplied from an outside source or a clock signal generated internally based on a signal supplied from an outside source. In general, a semiconductor integrated circuit includes a plurality of flip-flops and a circuit for generating a clock signal to be supplied to each flip-flop based on a provided clock signal (hereinafter, referred to as a clock circuit). In order to operate the semiconductor integrated circuit properly, it is necessary to appropriately supply a clock signal to each flip-flop. Also, in order to reduce power consumption of the semiconductor integrated circuit, it is effective to stop clock signal supply to a non-operating circuit block. Thus, it is recognized that a structure of a clock circuit and a supplying method of a clock signal present a significant challenge to a designer of the semiconductor integrated circuit.

An analysis of a clock circuit is generally performed by analyzing a portion of the clock circuit, the portion including a path over which a clock signal travels (hereinafter, referred to as a clock path) and logic cells on the clock path, as a clock tree. By such a clock tree analysis, a time required by a supplied clock signal to arrive at each flip-flop is calculated, for example. Then, a process for adding/removing a buffer, etc., to/from the clock circuit and a process for modifying layout results, for example, are performed based on analysis results of the clock tree so that clock skew (a difference in arrival times of supplied clocks to different flip-flops) is smaller than a predetermined acceptable value.

There have been known various techniques for designing a clock circuit included in the semiconductor integrated circuit. For example, the techniques described in the following documents are relevant to the invention in this application. Japanese Laid-Open Patent Publication No. H10-31688 discloses a verification editing device for presenting a circuit written in a language in visual form in order to facilitate design verification of the circuit. Japanese Laid-Open Patent Publication No. H2-110672 discloses a circuit diagram layout generating device capable of specifying a wiring width regarding a net list when a circuit diagram is inputted. Japanese Laid-Open Patent Publication No. H9-74138 discloses a layout verification method for identifying which portion of the net list is changed by modification, and performing design verification for the changed portion.

However, a clock circuit becomes large and complicated as a semiconductor integrated circuit to be designed becomes large and complicated, whereby designing a clock circuit becomes more and more difficult. For example, due to a large and complicated clock circuit, a designer has to spend considerable time learning a structure and function of the clock circuit. Also, it is difficult to analyze a clock circuit selectively supplying a plurality of clock signals. Also, due to a large and complicated circuit to be designed, more errors occur when a design constraint is imposed on the circuit based on analysis results of the clock circuit. Further, in the case where circuit modification is performed in the designing process, a circuit comparison may be performed for identifying which portion of a circuit is changed. However, if a name of a flip-flop is changed at the time of circuit modification, it is impossible to perform logical comparison by merely comparing the names of flip-flops.

### SUMMARY OF THE INVENTION

Therefore, an object of the present invention is to provide a method for processing design data of a clock circuit, etc., the method being provided with improved features compared to a conventional method.

The present invention has the following features to attain the object mentioned above.

A first aspect of the present invention is directed to a method for obtaining a circuit for display by removing a buffer and an inverter without changing logic from a clock circuit, and displaying the obtained circuit for display. In order to obtain the circuit for display, all buffers which do not change logic and, when a clock path is divided at a branch point of wiring, all pairs of inverters located on each divided clock path may be removed from the clock circuit. Alternatively, in order to obtain the circuit for display, a logic element located on a plurality of clock paths may be copied and added to the clock circuit, all buffers which do not change logic and all pairs of inverters located between logic elements other than the buffers which do not change logic may be removed, and redundant partial circuits, if any, realizing the same logic and being located on a plurality of clock paths may be removed.

Based on the above first aspect, a circuit from which the buffers and the inverters unnecessary for understanding the logic are removed is displayed, whereby a designer can understand the logic with ease.

A second aspect of the present invention is directed to a method for specifying a display color of a wire on which one clock signal is propagated and a display color of a wire on which a plurality of clock signals are propagated, differentiating between the wire on which one clock signal is propagated and the wire on which a plurality of clock signals are propagated, and displaying a clock circuit while displaying each wire using the specified display color.

Based on the above second aspect, the designer can easily understand a flow of a clock signal when he/she analyzes the clock circuit and imposes a circuit design constraint.

A third aspect of the present invention is directed to a method for specifying an association between a logic element located on a clock path and a logic element located on another clock path, and displaying a clock circuit including the above two clock paths so that the specified logic elements are aligned in a line horizontally or vertically across a screen.

Based on the above third aspect, the designer can easily understand a structure of a clock circuit when he/she analyzes the clock circuit and imposes a circuit design constraint.

A fourth aspect of the present invention is directed to a method for specifying a structure of a partial circuit to be displayed as one component, searching the specified partial circuit from a circuit to be displayed, and displaying the circuit to be displayed while displaying the partial circuit obtained as a result of searching as one component. In this case, in order to specify a partial circuit, an instance of a logic element or a type of logic element may be used.

Based on the above fourth aspect, a partial circuit having a special meaning is specified as a circuit to be displayed as one component, and the specified circuit is displayed as one component, whereby the designer can easily understand the structure of the circuit when he/she analyzes the circuit and imposes a circuit design constraint.

A fifth aspect of the present invention is directed to a method for obtaining attribute information of each wire from design data including a layout result of a circuit to be displayed, and displaying the circuit to be displayed while displaying each wire in a mode corresponding to the obtained attribute information.

Based on the above fifth aspect, each wire is displayed in a mode corresponding to the attribute information of the wire, whereby the designer can check the logic circuit and the wire information with ease.

A sixth aspect of the present invention is directed to a method for specifying a structure of a partial circuit and a design constraint to be imposed on the partial circuit, searching the specified partial circuit from a circuit to be processed, and imposing the specified design constraint on the partial circuit obtained as a result of searching. Also, it is possible to obtain a method for verifying a design constraint by determining whether or not the specified design constraint is imposed on the partial circuit obtained as a result of searching and outputting the determination results in place of imposing the design constraint.

Based on the above sixth aspect, it is possible to reduce mistakes in imposing a design constraint and the number of steps required to impose the design constraint.

A seventh aspect of the present invention is directed to a method for comparing circuits. By this method, a clock circuit is extracted from the respective two circuits to be compared, a group of storage elements to which a logically equivalent clock signal is supplied is obtained from each clock circuit, a group included in one clock circuit is associated with a group included in another clock circuit based on the number of storage elements belonging to each group, a storage element belonging to a group included in one clock circuit is associated with a storage element belonging to a group which is associated with the above group and is included in another clock circuit based on an instance name of each storage element, and logical comparison is performed for the two circuits using the obtained association between the storage elements as a constraint. In this case, logic reduction may be applied to each clock circuit, and a group composed of all storage elements to which a logically equivalent clock signal is supplied may be obtained from each clock circuit to which logic reduction is applied. Alternatively, a group composed of all storage elements to which a clock signal outputted from the same logic element is directly supplied may be obtained from each clock circuit.

Based on the above seventh aspect, it is possible to efficiently compare circuits even if the circuits do not include exactly the same number of flip-flops and a portion of flip-flops included in the circuits have different instance names.

An eighth aspect of the present invention is directed to a method for obtaining simplified design data of a clock circuit by obtaining, from a clock circuit, a group of storage elements to which a logically equivalent clock signal is supplied, and replacing the entirety of the storage elements with one storage element having an instance name including the number of storage elements belonging to each group. In this case, logic reduction may be applied to a clock circuit, and a group composed of all storage elements to which a logically equivalent clock signal is supplied may be obtained from the clock circuit to which logic reduction is applied. Alternatively, a group composed of all storage elements to which a clock signal outputted from the same logic element is directly supplied may be obtained from the clock circuit.

Based on the above eighth aspect, it is possible to generate simplified design data reflecting the number of flip-flops, whereby it is possible to perform circuit comparison, etc., with ease using the generated design data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of an EDA system used for executing a method according to each embodiment of the present invention;

FIG. 2 is a flowchart showing a clock circuit display method (first method) according to a first embodiment of the present invention;

FIGS. 3A and 3B are illustrations showing one example of execution of the clock circuit display method as shown in FIG. 2;

FIG. 4 is a flowchart showing a clock circuit display method (second method) according to the first embodiment of the present invention;

FIGS. 5A to 5D are illustrations showing one example of execution of the clock circuit display method as shown in FIG. 4;

FIGS. 6A and 6B are illustrations showing one example of execution of a step of removing a redundant circuit, the step being included in the clock circuit display method as shown in FIG. 4;

FIG. 7 is a flowchart showing a clock circuit display method according to a second embodiment of the present invention;

FIGS. 8A and 8B are illustrations showing one example of execution of the clock circuit display method as shown in FIG. 7;

FIGS. 9A to 9C are illustrations each showing a method for specifying a display color of a wire in the clock circuit display method as shown in FIG. 7;

FIG. 10 is a flowchart showing a clock circuit display method according to a third embodiment of the present invention;

FIGS. 11A and 11B are illustrations showing one example of execution of the clock circuit display method as shown in FIG. 10;

FIGS. 12A to 12C are illustrations each showing a method for specifying an association between logic elements in the clock circuit display method as shown in FIG. 10;

FIG. 13 is a flowchart showing a circuit display method according to a fourth embodiment of the present invention;

FIGS. 14A to 14D are illustrations for showing one example of execution of the circuit display method as shown in FIG. 13;

FIGS. 15A to 15G are illustrations each showing a method for specifying a to-be-black boxed circuit using an instance of a logic element in the circuit display method as shown in FIG. 13;

FIGS. 16A to 16G are illustrations each showing a method for specifying a to-be-black boxed circuit using a type of logic element in the circuit display method as shown in FIG. 13;

FIG. 17 is a flowchart showing a circuit display method according to a fifth embodiment of the present invention;

FIGS. 18A to 18D are illustrations showing one example of execution of the circuit display method as shown in FIG. 17;

FIG. 19 is a flowchart showing a method for imposing a design constraint according to a sixth embodiment of the present invention;

FIGS. 20A and 20B are illustrations showing one example of execution of the design constraint imposing method as shown in FIG. 19;

FIGS. 21A to 21C are illustrations showing a case in which a plurality of search results are obtained in the design constraint imposing method as shown in FIG. 19;

FIG. 22 is a flowchart showing a method for verifying a design constraint according to the sixth embodiment of the present invention;

FIG. 23 is a flowchart showing a circuit comparison method (first method) according to a seventh embodiment of the present invention;

FIGS. 24A to 24D are illustrations showing one example of execution of the circuit comparison method as shown in FIG. 23;

FIGS. 25A to 25D are illustrations showing another example of execution of the circuit comparison method as shown in FIG. 23;

FIG. 26 is a flowchart showing a circuit comparison method (second method) according to the seventh embodiment of the present invention;

FIGS. 27A to 27D are illustrations showing one example of execution of the circuit comparison method as shown in FIG. 26;

FIGS. 28A to 28D are illustrations showing another example of execution of the circuit comparison method as shown in FIG. 26;

FIG. 29 is a flowchart showing a method (first method) for obtaining design data of a clock circuit according to an eighth embodiment of the present invention;

FIGS. 30A and 30B are illustrations showing one example of execution of the method for obtaining design data of a clock circuit, the method shown in FIG. 29;

FIG. 31 is a flowchart showing a method (second method) for obtaining design data of a clock circuit according to the eighth embodiment of the present invention; and

FIGS. 32A and 32B are illustrations showing one example of execution of the method for obtaining design data of a clock circuit, the method shown in FIG. 31.

### DESCRIPTION OF THE PREFERRED EMBODIMENTS

Hereinafter, with reference to the drawings, methods for processing design data of a semiconductor integrated circuit according to first to eighth embodiments of the present invention will be described. Typically, the method according to each embodiment is executed using an EDA (Electronic Design Automation) system as shown in FIG. 1. An EDA system 10 as shown in FIG. 1 includes an input section 11, a processing section 12, a data storage section 13, and a display section 14. The data storage section 13 stores design data of a semiconductor integrated circuit. A designer inputs a command, etc., using the input section 11. In accordance with a command inputted from the input section 11, the processing section 12 performs various processes for the design data stored in the data storage section 13. The display section 14 displays a circuit diagram, etc., on a screen as processing results by the processing section 12.

(First Embodiment)

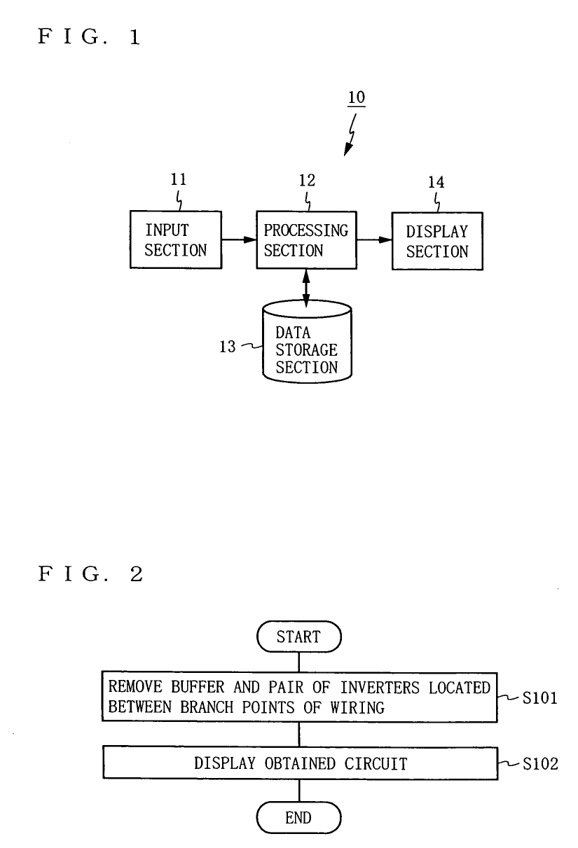

In a first embodiment of the present invention, a method for displaying a clock circuit to facilitate the designer's understanding of logic will be described. FIG. 2 is a flowchart showing a clock circuit display method (first method) according to the present embodiment. A process as shown in FIG. 2 is performed for a clock circuit composed of logic elements and wires located on a clock path. In order to specify a clock circuit to be displayed, a method for specifying a start point of a clock path, a method for specifying a logic element located at a root of the clock path, and a method for specifying logic elements or wires located on the clock path are used, for example.

In the process as shown in FIG. 2, all buffers which do not change logic are first removed from the clock circuit to be displayed. Also, in the case where the clock path is divided at each branch point of wiring, all pairs of inverters located on each divided clock path are removed from the clock circuit to be displayed (step S101). Next, the circuit obtained at step S101 is displayed on the screen (step S102). At step S102, the circuit from which the buffers and inverters are removed is displayed on the display section 14 of the EDA system 10 as shown in FIG. 1.

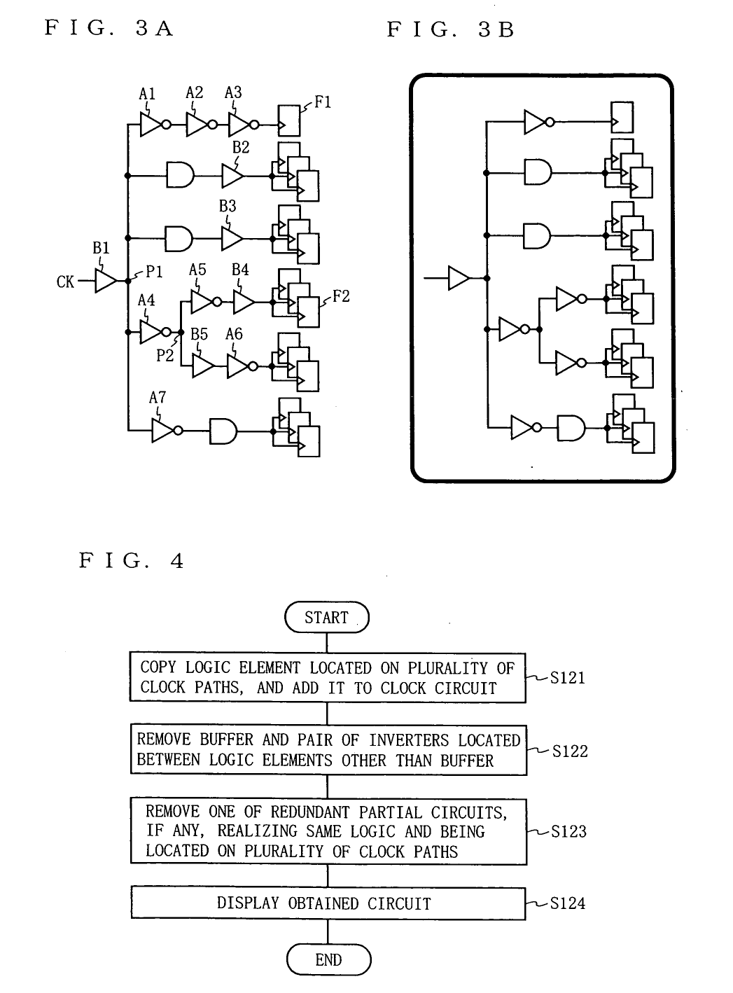

The details of a case in which a circuit as shown in FIG. 3A is displayed by the process as shown in FIG. 2 will be described below. The clock circuit as shown in FIG. 3A, which is composed of logic elements and wires located on the clock path, propagates a clock signal CK to each flip-flop. In the case where the process as shown in FIG. 2 is performed for this clock circuit, buffers B1 to B5, which do not change logic, are removed at step S101, and input signal lines of the buffers B1 to B5 are directly connected to the corresponding output signal lines. Also, in the case where each clock path included in the clock circuit is divided at a branch point of the wiring, there are three inverters A1 to A3 on the clock path from a wiring branch point P1 to a flip-flop F1. From among the above three inverters, an arbitrary pair of inverters (for example, a pair of inverters {A1, A2}) is removed, and input signal lines of the removed inverters are directly connected to the corresponding output signal lines. On the other hand, in the case where there is one inverter on each divided section, such an inverter is not removed. For example, there are two inverters (inverters A4 and A5) on the same clock path. However, the inverter A4 is located on a clock path from the wiring branch point P1 to a wiring branch point P2, and the inverter A5 is located on a clock path from the wiring branch point P2 to a flip-flop F2. Therefore, the inverter A4 and the inverter A5 are not removed.

As a result, when step S101 is executed for the clock circuit as shown in FIG. 3A, a circuit as shown in FIG. 3B is obtained, and this circuit is displayed on the screen at step S102. Comparison between the circuit as shown in FIG. 3A and the circuit as shown in FIG. 3B shows that the buffers and inverters unnecessary for understanding the logic are removed from the latter. Also, in the circuit as shown in FIG. 3B, a branch structure of the original circuit is unchanged. Thus, by displaying the circuit as shown in FIG. 3B in place of the circuit as shown in FIG. 3A, the designer can understand the logic with ease.

As described above, based on the circuit display method as shown in FIG. 2, it is possible to display a circuit from which buffers and inverters unnecessary for understanding the logic are removed while keeping a branch structure, whereby the designer can understand the logic with ease.

FIG. 4 is a flowchart showing a clock circuit display method (second method) according to the present embodiment. As is the case with the process as shown in FIG. 2, a process as shown in FIG. 4 is performed for a clock circuit composed of logic elements and wires located on a clock path. In the process as shown in FIG. 4, a circuit for display is obtained by executing steps S121 to S123 for a clock circuit to be displayed.

More specifically, a logic element/logic elements located on a plurality of clock paths is/are first copied, and the duplicate logic element/logic elements is/are added to a clock circuit to be displayed so that the clock paths are independent of each other (step S121). At step S121, however, clock paths which share a portion from the root to the last logic element may be regarded as one clock path. Next, from the clock circuit to which the logic element/logic elements is/are added, all buffers which do not change logic and all pairs of inverters located between logic elements other than the buffers which do not change logic are removed (step S122). Next, from the clock circuit from which the buffers and the pairs of inverters are removed, redundant partial circuits, if any, realizing the same logic and being located on a plurality of clock paths are removed so that each clock path has a common section (step S123).

Next, a circuit obtained after executing steps S121 to S123 is displayed on the screen (step S124). This circuit is displayed on the display section 14 of the EDA system 10 as shown in FIG. 1.

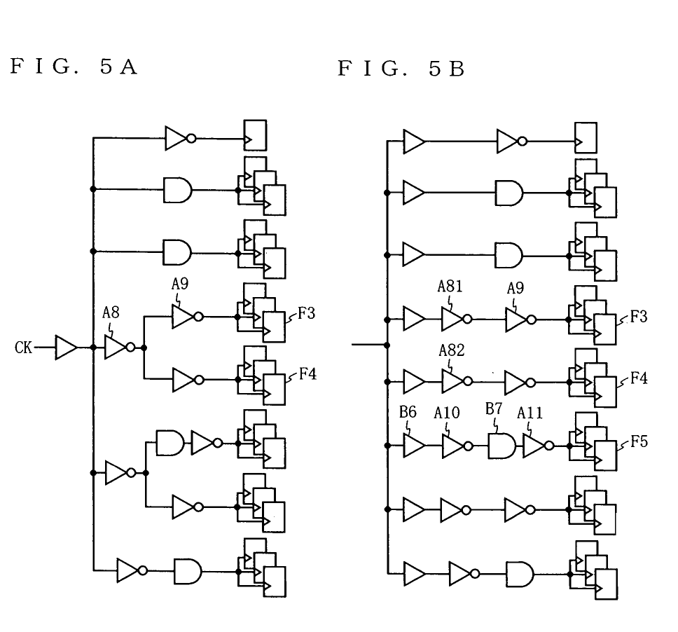

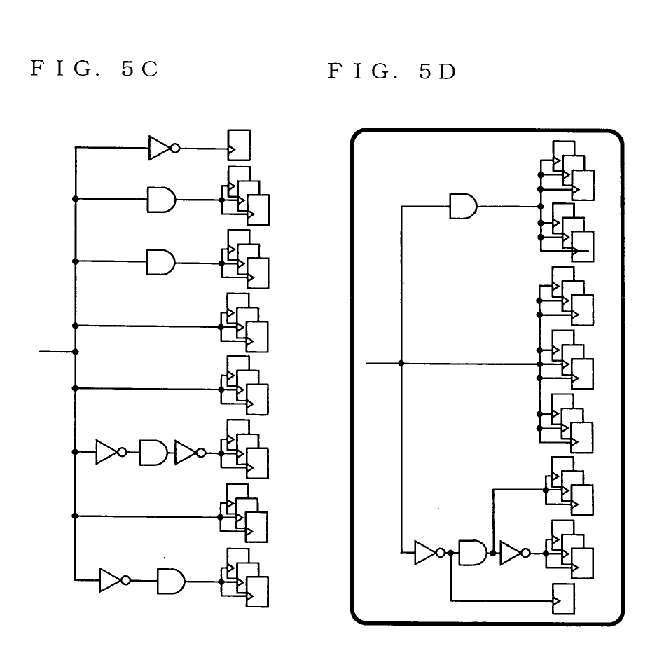

The details of a case in which a circuit as shown in FIG. 5A is displayed by the process as shown in FIG. 4 will be described below. As is the case with the clock circuit as shown in FIG. 3A, the clock circuit as shown in FIG. 5A, which is composed of logic elements and wires located on a clock path, propagates a clock signal CK to each flip-flop. When step S121 is executed for this circuit, a circuit as shown in FIG. 5B is obtained. For example, in the circuit as shown in FIG. 5A, an inverter A8 is located not only on a clock path leading into a flip-flop F3 but also on a clock path leading into a flip-flop F4; these two clock paths are not independent of each other. Thus, in order to perform circuit modification to obtain separate two clock paths while keeping original logic, the inverter A8 is copied to obtain an inverter A81 and an inverter A82 (see FIG. 5B). The inverters A81 and A82 are deployed on the clock path leading into the flip-flop F3 and the clock path leading into the flip-flop F4, respectively.

Next, when step S122 is executed for the circuit as shown in FIG. 5B, a circuit as shown in FIG. 5C is obtained. For example, in the circuit as shown in FIG. 5B, two inverters (inverter A81 and inverter A9) are located on the clock path leading into the flip-flop F3. Thus, a pair of inverters {A81, A9} is removed, and input signal lines of the removed inverters are directly connected to the corresponding output signal lines. Also, two inverters (inverter A10 and inverter A11) are located on a clock path leading into a flip-flop F5. In this case, however, one inverter (inverter A10) is located on a clock path from a buffer B6 to an AND gate B7, and the other inverter (inverter A11) is located on a clock path from the AND gate B7 to the flip-flop F5. As a result, the inverters A10 and A11 are not removed.

Next, when step S123 is executed for the circuit as shown in FIG. 5C, a circuit as shown in FIG. 5D is obtained. At step S123, after obtaining a connection relationship of the logic elements located on the clock path, a connection relationship of the circuit may be changed to remove a redundant partial circuit.

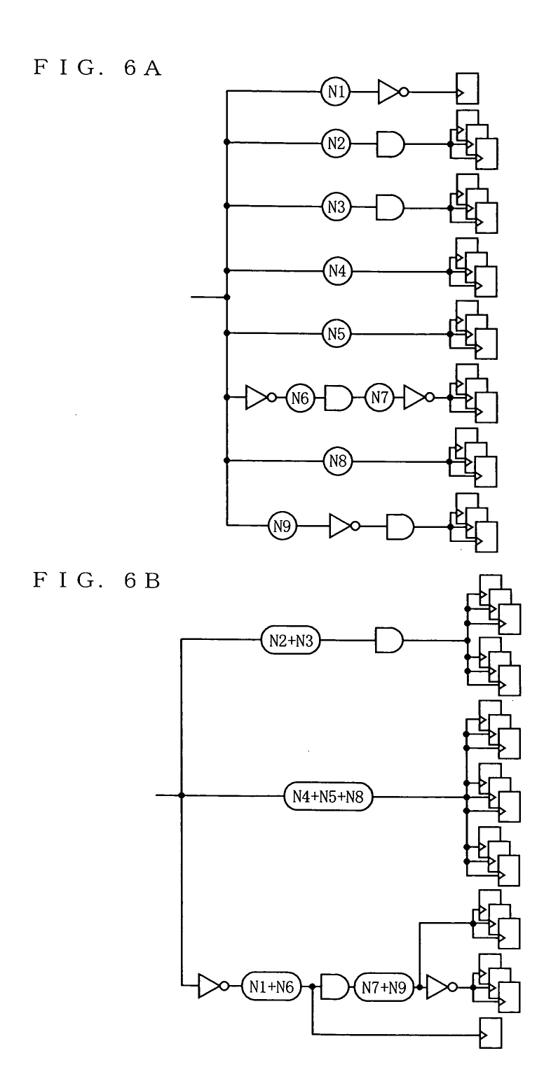

FIGS. 6A and 6B are illustrations for describing the details of step S123. At step S123, as shown in FIG. 6A, nodes N1 to N9 are provided on the respective clock paths of the circuit obtained at step S122 (FIG. 5C). Either a circuit after the node N2 or a circuit after the node N3 is removed since the above two circuits have the same structure, and the nodes N2 and N3 are merged into one node. Also, the nodes N4, N5, and N8 are merged into one node since there are no circuits after the above three nodes. Also, a circuit after the node N1 is removed since the above circuit has the same structure as a circuit before the node N6, and the nodes N1 and N6 are merged into one node. Further, a circuit after the node N9 is removed since the above circuit has the same structure as a circuit before the node N7, and the nodes N7 and N9 are merged into one node. As such, by removing a redundant circuit, a circuit as shown in FIG. 6B is obtained. This circuit is the same as the circuit as shown in FIG. 5D.

Comparison between the circuit as shown in FIG. 5A and the circuit as shown in FIG. 5D shows that the buffers and inverters unnecessary for understanding the logic are removed from the latter. Further, although the circuit as shown in FIG. 5D does not have an original branch structure of the circuit as it was, it includes a certain amount of information necessary for understanding the circuit structure. Thus, by displaying the circuit as shown in FIG. 5D in place of the circuit as shown in FIG. 5A, the designer can understand the logic with ease.

As such, based on the clock circuit display method as shown in FIG. 4, it is possible to display a circuit from which buffers and inverters unnecessary for understanding the logic are removed while keeping a certain amount of information necessary for understanding the circuit structure, whereby the designer can understand the logic with ease.

(Second Embodiment)

In a second embodiment of the present invention, a clock circuit display method for facilitating the designer's understanding of a flow of a clock signal will be described. FIG. 7 is a flowchart showing a clock circuit display method according to the present embodiment. A process as shown in FIG. 7 is executed for a clock circuit composed of logic elements and wires located on a plurality of clock paths. A clock circuit to be displayed is specified by the method as described in the first embodiment, for example.

In the process as shown in FIG. 7, a display color of a wire on which each clock signal is propagated and a display color of a wire on which a plurality of clock signals are propagated are first specified (step S201). Next, a clock circuit to be displayed is displayed while displaying each wire using the display color specified at step S201 for differentiating between the wire on which each clock signal is propagated and the wire on which a plurality of clock signals are propagated (step S202).

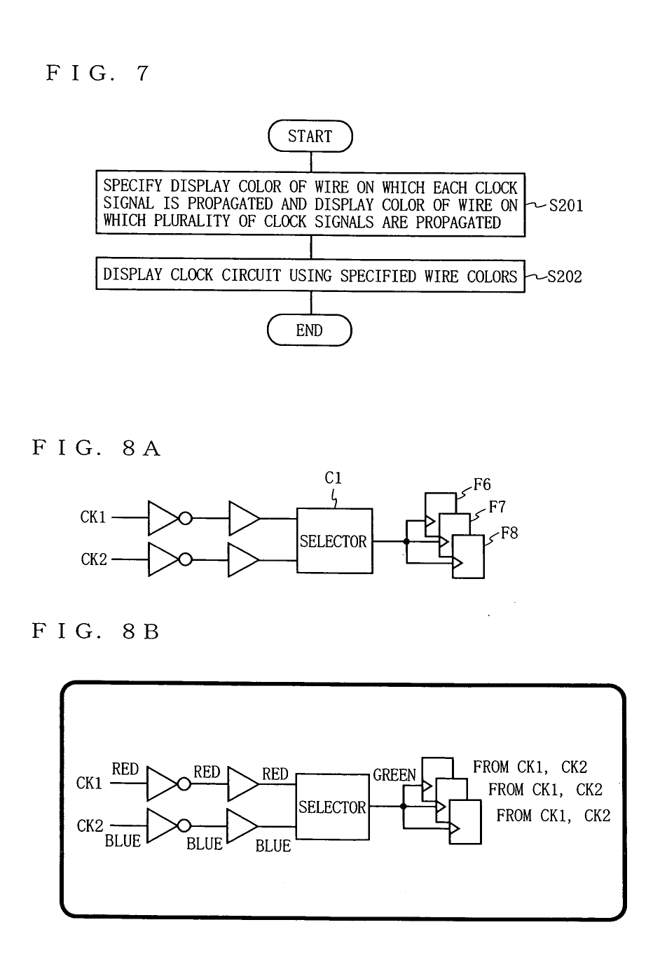

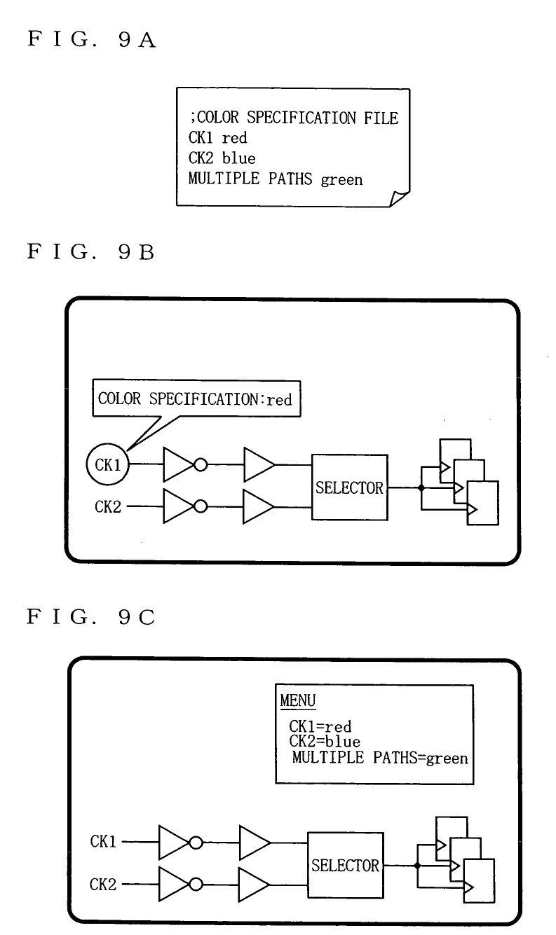

The details of a case in which a circuit as shown in FIG. 8A is displayed by the process as shown in FIG. 7 will be described below. In the circuit as shown in FIG. 8A, a clock signal supplied from a clock input terminal CK1 and a clock signal supplied from a clock input terminal CK2 are propagated. There are various methods for specifying a display color of a wire included in the above circuit. For example, as a first method, it is possible to specify a display color of a wire using a color specification file as shown in FIG. 9A. In the color specification file as shown in FIG. 9A, it is described that a wire on which only a clock signal supplied from the clock input terminal CK1 is propagated is displayed using red, a wire on which only a clock signal supplied from the clock input terminal CK2 is propagated is displayed using blue, and a wire on which a plurality of clock signals are propagated is displayed using green.

Alternatively, as a second method, a display color of a wire may be specified by selecting a clock input terminal on the screen as shown in FIG. 9B. In FIG. 9B, the clock input terminal CK1 is selected on the screen while the clock circuit to be displayed is displayed on the screen, and red is specified as a display color of a wire on which only a clock signal supplied from the clock input terminal CK1 is propagated. In this case, a display color of a wire on which only a clock signal supplied from the clock input terminal CK2 is propagated is specified in a similar manner. A display color of a wire on which a plurality of clock signals are propagated is arbitrarily selected from among colors which are not selected for the clock input terminals CK1 and CK2.

Alternatively, as a third method, a display color of a wire may be specified using a menu displayed on the screen as shown in FIG. 9C. In FIG. 9C, a display color of a wire is specified using a color specification menu while a clock circuit to be displayed and the color specification menu are concurrently displayed on the screen. Information to be inputted to the color specification menu as shown in FIG. 9C is identical to the information described in the color specification file as shown in FIG. 9A.

In the case where the clock circuit as shown in FIG. 8A is displayed after a display color of a wire is specified using any of the above-described first to third methods or using another method, a circuit as shown in FIG. 8B is obtained. That is, a wire from the clock input terminal CK1 to a selector C1 is displayed using red on the screen since only a clock signal supplied from the clock input terminal CK1 is propagated on the above wire. Also, a wire from the clock input terminal CK2 to the selector C1 is displayed using blue on the screen since only a clock signal supplied from the clock input terminal CK2 is propagated on the above wire. Further, a wire from the selector C1 to flip-flops F6 to F8 is displayed using green on the screen since two types of clock signals supplied from the clock input terminals CK1 and CK2 are propagated on the above wire.

Also, in the case where a clock circuit is displayed on the screen, characters may be displayed near each flip-flop to indicate a supply source of the clock signal received by each flip-flop. In the screen as shown in FIG. 8B, the words “FROM CK1, CK2” are displayed near each of flip-flops F6 to F8.

As described above, based on the clock circuit display method according to the present embodiment, the designer can easily understand a flow of a clock signal when he/she analyzes a clock circuit and imposes a circuit design constraint.

(Third Embodiment)

In a third embodiment of the present invention, a clock circuit display method for facilitating the designer's understanding of a structure will be described. FIG. 10 is a flowchart showing the clock circuit display method according to the present embodiment. A process as shown in FIG. 10 is executed for a clock circuit composed of logic elements and wires located on a plurality of clock paths. A clock circuit to be displayed is specified by the method as described in the first embodiment, for example.

In the process as shown in FIG. 10, an association between a logic element located on a clock path of the clock circuit to be displayed and a logic element located on another clock path of the same clock circuit is first specified (step S301). At step S301, a plurality of associations between the logic elements located on two clock paths may be specified, and an association between the logic elements located on three or more different clock paths may be specified. Next, the clock circuit to be displayed is displayed so that the logic elements specified at step S301 are aligned in a line horizontally or vertically across the screen (step S302). In order to display the specified logic elements in a line, a stage number of each of the specified logic elements is first obtained, and a largest stage number is determined as a maximum value M. Then, all the specified logic elements are displayed at M stage.

The details of a case in which a circuit as shown in FIG. 11A is displayed by the process as shown in FIG. 10 will be described below. The circuit as shown in FIG. 1A includes a first clock path from a clock input terminal CK3 to a flip-flop D4 and a second clock path from a clock input terminal CK4 to a flip-flop D9. There are various methods for specifying an association between a logic element located on the first clock path and a logic element located on the second clock path. For example, as a first method, it is possible to specify an association between logic elements using an indent specification file as shown in FIG. 12A. In the indent specification file as shown in FIG. 12A, it is described that a logic element whose instance name is D3 is associated with a logic element whose instance name is D6, and a logic element whose instance name is D4 is associated with a logic element whose instance name is D9.

Alternatively, as a second method, an association between logic elements may be specified by selecting a logic element located on a clock path as shown in FIG. 12B. In FIG. 12B, an AND gate D3 and an AND gate D6 are enclosed with a box (indicated by a dashed line) while the clock circuit to be displayed is displayed on the screen, thereby specifying an association between these two AND gates. An association between the flip-flops D4 and D9 is specified in a similar manner.

Alternatively, as a third method, an association between logic elements may be specified using a menu displayed on the screen as shown in FIG. 12C. In FIG. 12C, an association between logic elements is specified using an indent specification menu while the clock circuit to be displayed and the indent specification menu are concurrently displayed on the screen. Information to be inputted to the indent specification menu as shown in FIG. 12C is identical to the information described in the indent specification file as shown in FIG. 12A.

In the case where the clock circuit as shown in FIG. 11A is displayed after an indent is specified using any of the above-described first to third methods or using another method, a circuit as shown in FIG. 11B is obtained. That is, the AND gates D3 and D6 aligned in a line vertically across the screen are displayed, and the flip-flops D4 and D9 are displayed in a similar manner. Thus, by displaying the circuit as shown in FIG. 11B in place of the circuit as shown in FIG. 11A, the designer can understand the circuit structure with ease.

As described above, based on the clock circuit display method according to the present embodiment, the designer can easily understand the structure of a clock circuit when he/she analyzes the clock circuit and imposes a circuit design constraint.

(Fourth Embodiment)

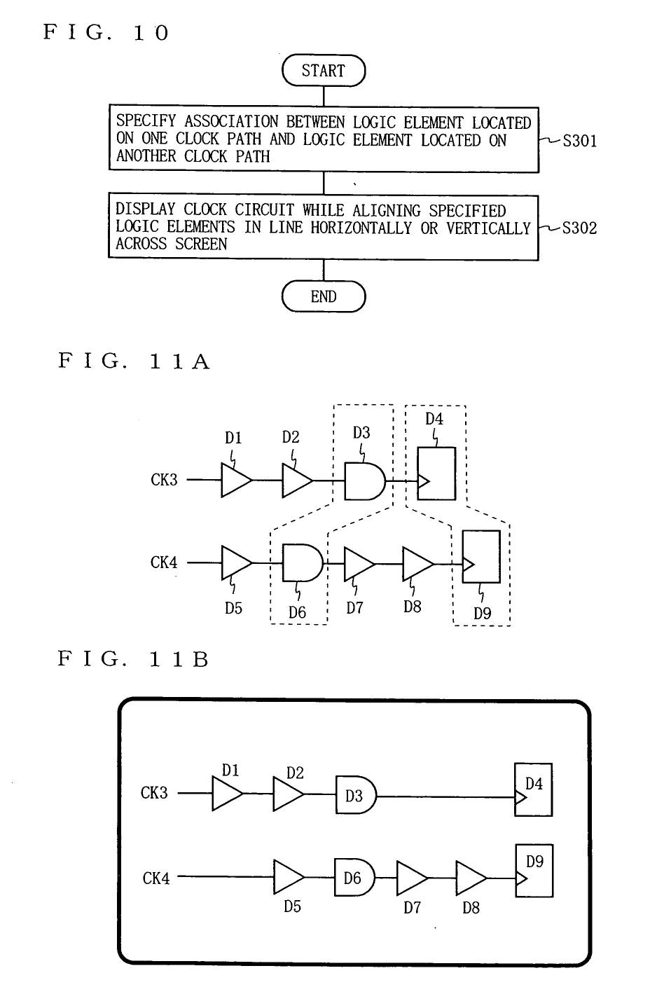

In a fourth embodiment of the present invention, a circuit display method for facilitating the designer's understanding of a structure will be described. FIG. 13 is a flowchart showing the circuit display method according to the present embodiment. A process as shown in FIG. 13 is performed for a circuit to be displayed, especially, for a clock circuit composed of logic elements and wires located on a clock path. When a clock circuit to be displayed is specified, the method as described in the first embodiment is used, for example.

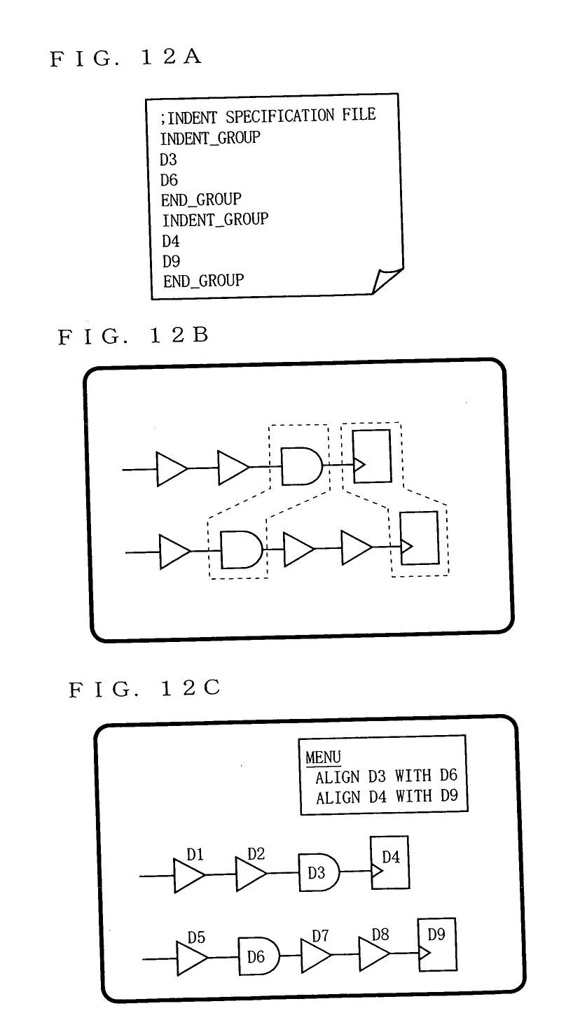

In the process as shown in FIG. 13, a structure of a partial circuit to be displayed as a black box (hereinafter, referred to as a to-be-black boxed circuit) is first specified (step 401). Here, a to-be-black boxed circuit is a partial circuit, which is composed of a plurality of logic elements and at least one connection and is to be displayed as one component. Typically, a partial circuit having a logical meaning is specified as a to-be-black boxed circuit. For example, the clock circuit may include a selection circuit as shown in FIG. 14A and a delay circuit as shown in FIG. 14B. Thus, when the clock circuit is displayed by the process as shown in FIG. 13, a partial circuit frequently used in the clock circuit is specified as a to-be-black boxed circuit.

Next, the to-be-black boxed circuit specified at step S401 is searched from the circuit to be displayed (step S402). At step S402, a process for detecting circuit matching is performed between the circuit to be displayed and the to-be-black boxed circuit. Next, the circuit to be displayed is displayed while the to-be-black boxed circuit obtained at step S402 is displayed as one black box (step S403). As a result, for example, the selection circuit as shown in FIG. 14A is displayed as one black box as shown in FIG. 14C, and the delay circuit as shown in FIG. 14B is displayed as one black box as shown in FIG. 14D.

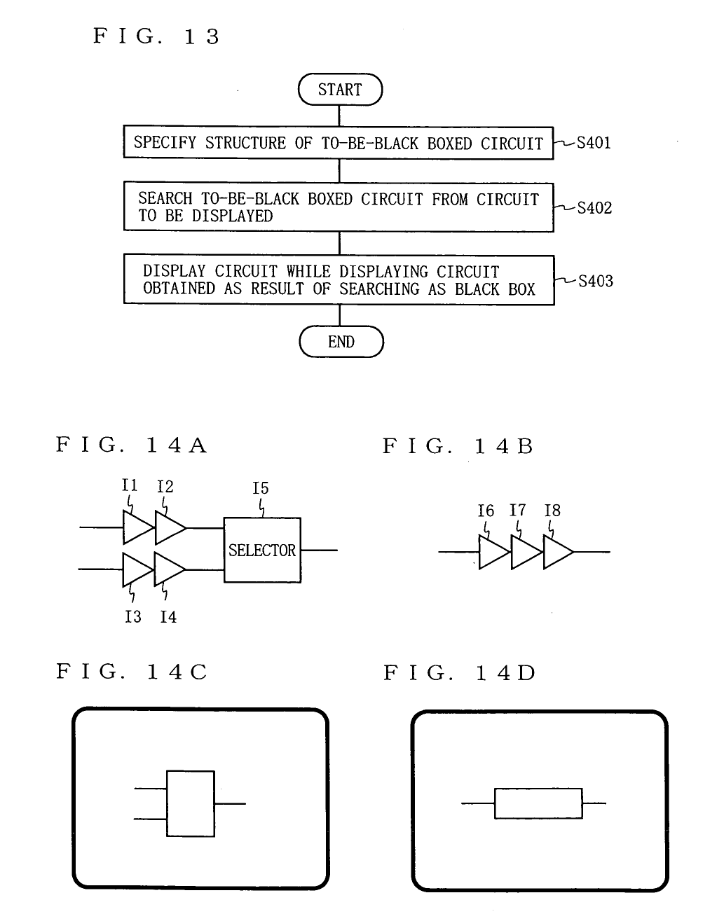

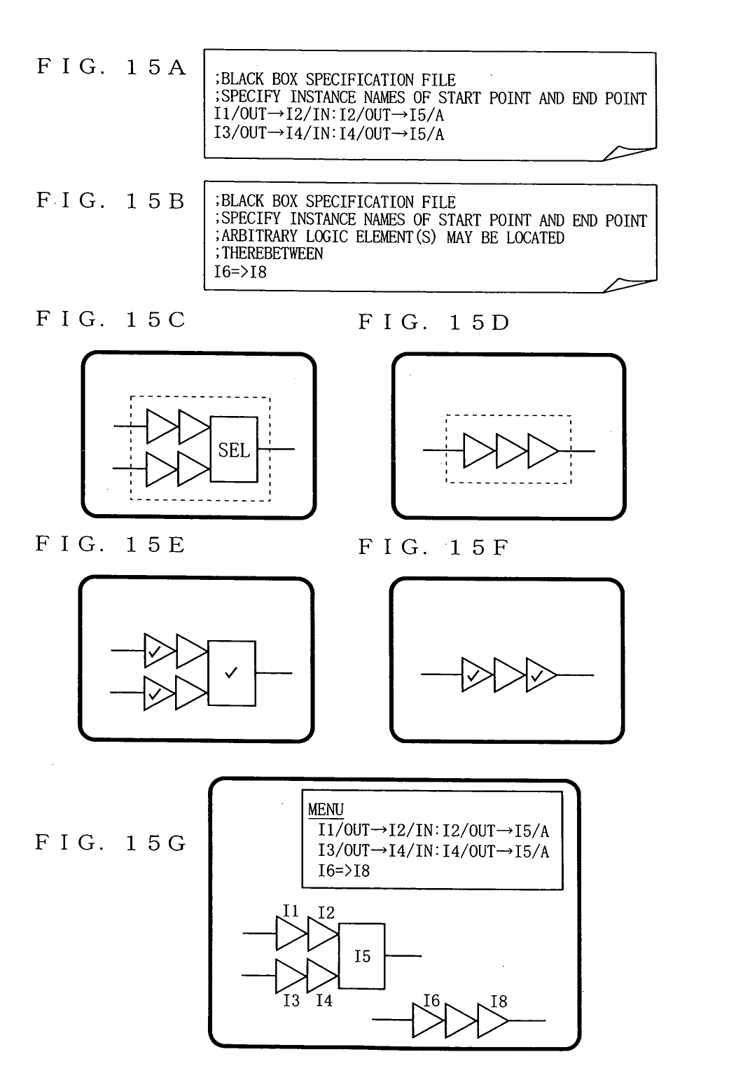

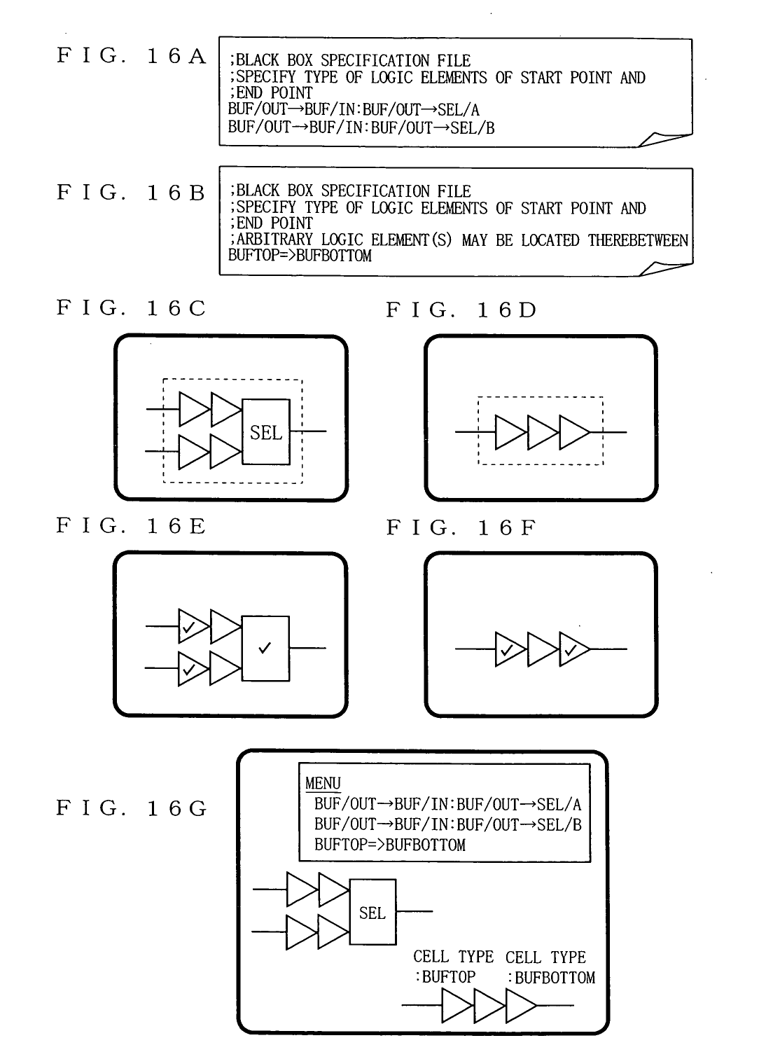

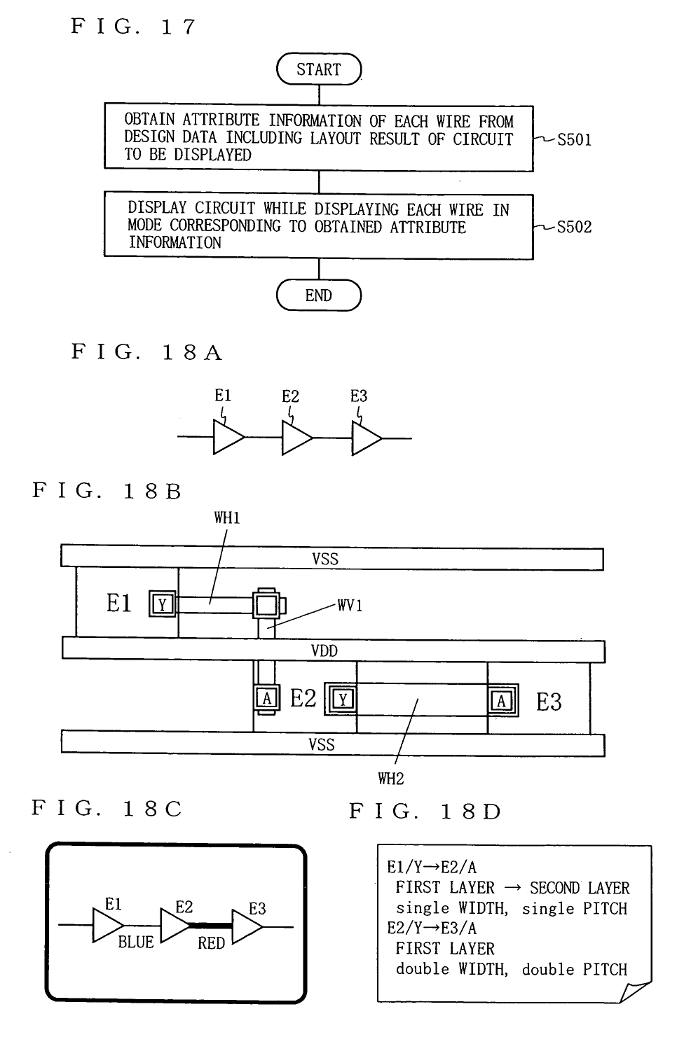

With reference to FIGS. 15A to 15G and 16A to 16G, methods for specifying the circuits as shown in FIGS. 14A and 14B as a to-be-black boxed circuit will be described. The method for specifying a to-be-black boxed circuit includes, for example, a specification method using an instance of a logic element and a specification method using a type of logic element. By the specification method using an instance of a logic element, only a specified circuit is displayed as a black box. On the other hand, by the specification method using a type of logic element, all circuits having the same structure as the specified circuit are displayed as separate black boxes.

As a first method using an instance of a logic element, it is possible to specify a to-be-black boxed circuit using a black box specification file as shown in FIGS. 15A and 15B. FIG. 15A shows a black box specification file for the circuit as shown in FIG. 14A. In this file, a start point and an end point of a to-be-black boxed circuit are specified using an instance name of a logic element. More specifically, in this file, it is described that (1) an OUT terminal of a logic element whose instance name is I1 is connected to an IN terminal of a logic element whose instance name is I2, (2) an OUT terminal of a logic element whose instance name is I2 is connected to an A terminal of a logic element whose instance name is I5, (3) an OUT terminal of a logic element whose instance name is I3 is connected to an IN terminal of a logic element whose instance name is I4, and (4) an OUT terminal of a logic element whose instance name is I4 is connected to a B terminal of a logic element whose instance name is I5. As a result, a circuit in which the logic elements whose instance names are I1 to I5 are connected in a manner as described in the above items (1) to (4) is specified as a to-be-black boxed circuit.

FIG. 15B shows a black box specification file for the circuit as shown in FIG. 14B. This file describes a logic element whose instance name is I6 and a logic element whose instance name is I8. Also, a symbol “=>” written between the above two logic elements in the file indicates that an arbitrary number of logic elements may be located between the above two logic elements in the circuit. Thus, an arbitrary circuit in which a logic element whose instance name is I6 is located at a first stage and a logic element whose instance name is I8 is located at a last stage is specified as a to-be-black boxed circuit. For example, in the circuit as shown in FIG. 14B, a logic element whose instance name is I6 is located at a first stage and a logic element whose instance name is I8 is located at a last stage, and a logic element whose instance name is I7 is located between the above two logic elements. Thus, this circuit is specified as a to-be-black boxed circuit by the black box specification file as shown in FIG. 15B. Also, in the circuit as shown in FIG. 14B, a circuit in which the buffer 17 is replaced with two and more buffers is specified as a to-be-black boxed circuit by the black box specification file as shown in FIG. 15B.

Alternatively, as a second method using an instance of a logic element, a to-be-black boxed circuit may be specified by selecting logic elements displayed on the screen and putting a box around the logic elements, as shown in FIGS. 15C and 15D. In FIG. 15C, a box (indicated by a dashed line) is put around buffers I1 to I4 and a selector I5 while the clock circuit to be displayed is displayed on the screen. As a result, a circuit composed of the above five logic elements and wires connecting these logic elements is specified as a to-be-black boxed circuit. In FIG. 15D, a box is put around buffers 16 to 18 while the circuit to be displayed is displayed on the screen. As a result, a circuit composed of the above three logic elements and wires connecting these logic elements is specified as a to-be-black boxed circuit.

Alternatively, as a third method using an instance of a logic element, a to-be-black boxed circuit may be specified by selecting a start point logic element and an end point logic element of the to-be-black boxed circuit on the screen as shown in FIGS. 15E and 15F. In FIG. 15E, the buffers I1 and I3 and the selector I5 are selected by putting a mark (check) while the circuit to be displayed is displayed on the screen. As a result, a circuit composed of the above three logic elements, logic elements located between these three logic elements, and wires connecting the above logic elements is specified as a to-be-black boxed circuit. In FIG. 15F, the buffers I6 and I8 are selected by putting a mark while the clock circuit to be displayed is displayed. As a result, a circuit composed of the above two logic elements, a logic element located between these two logic elements, and wires connecting the above logic elements is specified as a to-be-black boxed circuit.

Alternatively, as a fourth method using an instance of a logic element, a to-be-black boxed circuit may be specified using a menu displayed on the screen as shown in FIG. 15G. In FIG. 15G, a to-be-black boxed circuit is specified using a black box specification menu while the clock circuit to be displayed and the black box specification menu are concurrently displayed on the screen. Information to be inputted to the black box specification menu as shown in FIG. 15G is identical to the information described in the black box specification file as shown in FIGS. 15A and 15B.

As a first method using a type of logic element, it is possible to specify a to-be-black boxed circuit using a black box specification file as shown in FIGS. 16A and 16B. FIG. 16A is a black box specification file for the circuit as shown in FIG. 14A. In this file, a start point and an end point of the circuit as shown in FIG. 14A are specified using a type of logic element. More specifically, in this file, it is described that (1) an OUT terminal of a first logic element whose cell type is BUF (buffer) is connected to an IN terminal of a second logic element whose cell type is BUF, (2) an OUT terminal of the second logic element whose cell type is BUF is connected to an A terminal of a logic element whose cell type is SEL (selector), (3) an OUT terminal of a third logic element whose cell type is BUF is connected to an IN terminal of a fourth logic element whose cell type is BUF, and (4) an OUT terminal of the fourth logic element whose cell type is BUF is connected to a B terminal of the logic element whose cell type is SEL. As a result, a circuit in which the first to fourth logic elements whose cell types are BUF and the logic element whose cell type is SEL are connected in a manner as described in the above items (1) to (4) is specified as a to-be-black boxed circuit.

FIG. 16B shows a black box specification file for the circuit as shown in FIG. 14B. This file describes a first logic element whose cell type is BUFTOP (buffer) and a second logic element whose cell type is BUFBOTTOM (buffer). Also, a symbol “=<” written between the above two logic elements in the file indicates that an arbitrary number of logic elements may be located between the above two logic elements in the circuit. As a result, a circuit in which a logic element whose cell type is BUFTOP is located at a first stage and a logic element whose cell type is BUFBOTTOM is located at a last stage is specified as a to-be-black boxed circuit.

Alternatively, as a second method using a type of logic element, a to-be-black boxed circuit may be specified by selecting logic elements displayed on the screen and putting a box around the logic elements as shown in FIGS. 16C and 16D. Alternatively, as a third method using a type of logic element, a to-be-black boxed circuit may be specified by selecting a start point logic element and an end point logic element of the to-be-black boxed circuit on the screen as shown in FIGS. 16E and 16F. Note that FIGS. 16C to 16F are identical to FIGS. 15C to 15F, respectively. However, by the second and third methods using a type of logic element, once a circuit is specified as a to-be-black boxed circuit on the screen, all circuits having the same structure as the specified circuit are specified as separate to-be-black boxed circuits.

Alternatively, as a fourth method using a type of logic element, a to-be-black boxed circuit may be specified using a menu displayed on the screen as shown in FIG. 16G. In FIG. 16G, a to-be-black boxed circuit is specified using a black box specification menu while the clock circuit to be displayed and the black box specification menu are concurrently displayed on the screen. Information to be inputted to the black box specification menu as shown in FIG. 16G is identical to the information described in the black box specification file as shown in FIGS. 16A and 16B.

As described above, based on the circuit display method according to the present embodiment, a partial circuit having a special meaning is specified as a to-be-black boxed circuit, and the specified circuit is displayed as a black box, whereby the designer can easily understand the structure of the circuit when he/she analyzes the circuit and imposes a circuit design constraint.

(Fifth Embodiment)

In a fifth embodiment of the present invention, a circuit display method for facilitating the designer's understanding of the attribute of a wire will be described. FIG. 17 is a flowchart showing the circuit display method according to the present embodiment. A process as shown in FIG. 17 is performed for a clock circuit composed of logic elements and wires located on a clock path. A clock circuit to be displayed is specified by the method as described in the first embodiment, for example.

In the process as shown in FIG. 17, attribute information of each wire is first obtained from design data including a layout result of the circuit to be displayed (step S501). The attribute information obtained at step S501 includes the width of a wire, a wiring pitch, and layer information (information indicating on which layer a wire is located), for example. Next, the circuit to be displayed is displayed while each wire is displayed in a mode corresponding to the attribute information obtained at step S501 (step S502). In this case, too many wire attribute information displayed on the screen hinders the designer from understanding the wire attribute rather than facilitates his/her understanding. Thus, the entire or a portion of the wire attribute information may be outputted to a file.

The details of a case in which a circuit as shown in FIG. 18A is displayed by the process as shown in FIG. 17 will be described below. The circuit as shown in FIG. 18A includes buffers E1 to E3. With regard to this circuit, assume that layout results as shown in FIG. 18B are obtained. Based on the layout results as shown in FIG. 18B, a first wire from the buffer E1 to the buffer E2 is composed of a horizontal wire WH1 and a vertical wire WV1. Assume that the horizontal wire WH1 is a single-wide wire located on a first wire layer at a single pitch, and the vertical wire WV1 is single-wide wire located on a second wire layer at a single pitch. Also, a second wire from the buffer E2 to the buffer E3 is composed of only a horizontal wire WH2. Assume that the horizontal wire WH2 is a double-wide wire located on the first wire layer at a double pitch.

When the process as shown in FIG. 17 is performed for the clock circuit as shown in FIG. 18A, attribute information such as the width of a wire, a wiring pitch, and layer information of the first wire from the buffer E1 to the buffer E2 and the second wire from the buffer E2 to the buffer E3 is obtained at step S501. When the circuit is displayed at step S502, a display mode of a wire is determined in accordance with an attribute of the wire. For example, a single-wide wire located at a single pitch is assigned a blue thin line, and a double-wide wire located at a double pitch is assigned a red heavy line. As such, when the circuit as shown in FIG. 18A is displayed after a display mode of a wire is determined in accordance with an attribute of the wire, a circuit as shown in FIG. 18C is obtained. That is, the first wire from the buffer E1 to the buffer E2 is displayed on the screen as a blue thin line, and the second wire from the buffer E2 to the buffer E3 is displayed on the screen as a red heavy line. Note that the width of a line may be represented by changing only a display color without changing the line width.

Also, at step S502, attribute information of a wire is outputted to a file. As a result, with regard to the circuit as shown in FIG. 18A, for example, output results as shown in FIG. 18D are obtained. The output results as shown in FIG. 18D describe that a wire from a Y terminal of a logic element whose instance name is E1 to an A terminal of a logic element whose instance name is E2 is a single-wide wire located on the first and second wire layers at a single pitch, and a wire from a Y terminal of a logic element whose instance name is E2 to an A terminal of a logic element whose instance name is E3 is a double-pitch wire located on the first wire layer at a double pitch.

As described above, based on the circuit display method according to the present embodiment, each wire is displayed in a mode corresponding to the attribute information of the wire, whereby the designer can check the logic circuit and the wire information with ease.

(Sixth Embodiment)

In a six embodiment of the present invention, a method for imposing a design constraint on circuit design data and a method for verifying the design constraint imposed on the circuit design data will be described. FIG. 19 is a flowchart showing the method for imposing a design constraint according to the present embodiment. A process shown in FIG. 19 is performed for a circuit whose logic level design has been completed.

In the process as shown in FIG. 19, a structure of a partial circuit including a plurality of logic elements and at least one wire and a design constraint to be imposed on the partial circuit are first specified (step S601). Hereinafter, the circuit specified at step S601 is referred to as a constraint-imposed circuit. At step S601, a plurality of constraint-imposed circuits may be specified. Next, the constraint-imposed circuit specified at step S601 is searched from the circuit to be processed (step S602). Next, the design constraint specified at step S601 is imposed on the circuit obtained at step S602 (step S603).

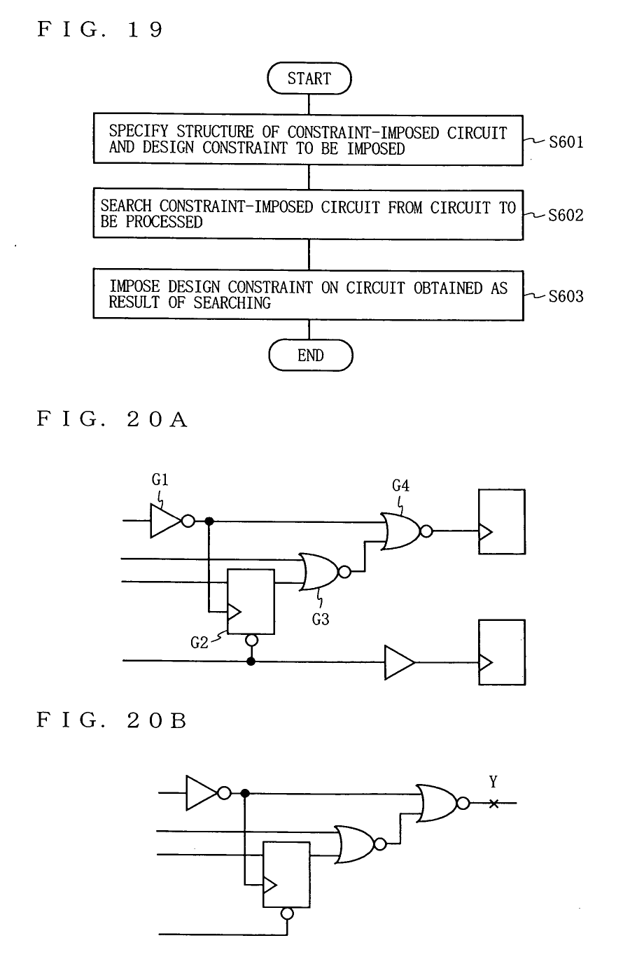

The details of a case in which a design constraint is imposed on a circuit as shown in FIG. 20A by the process as shown in FIG. 19 will be described below. At step S601, assume that a circuit as shown in FIG. 20B is specified as a constraint-imposed circuit, and a constraint such as “changing a phase of a clock signal” is imposed on an output signal Y as a design constraint regarding this circuit. At step S602, a partial circuit having the same structure as shown in FIG. 20B is searched from the circuit as shown in FIG. 20A. In the circuit as shown in FIG. 20A, a partial circuit composed of a buffer G1, a flip-flop G2, NOR gates G3 and G4, and wires connecting the above four logic elements has the same structure as the constraint-imposed circuit. Thus, at step S603, a constraint such as “changing a phase of a clock signal” is imposed on an output terminal of the NOR gate G4.

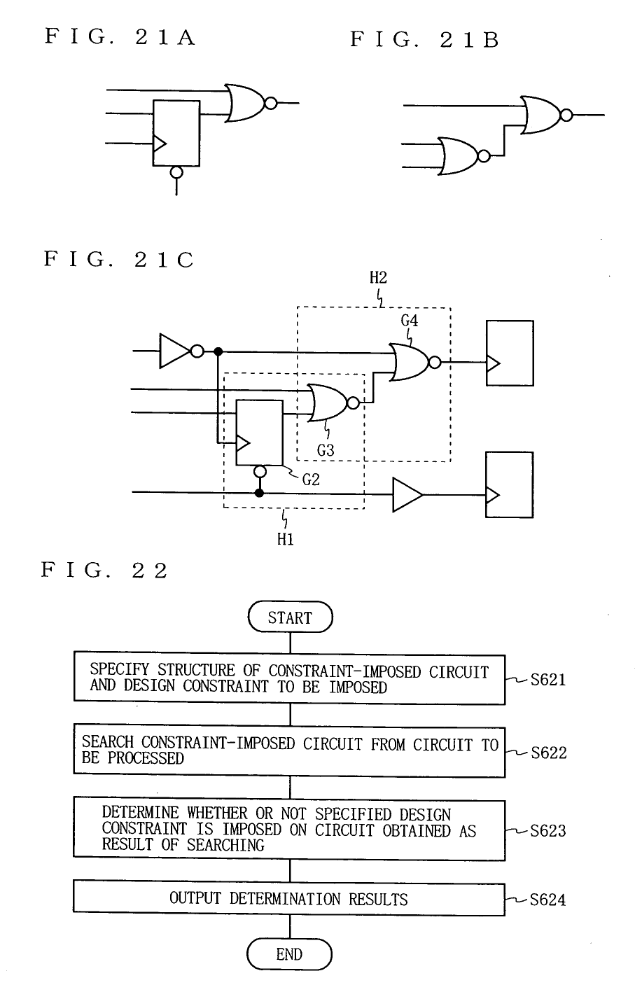

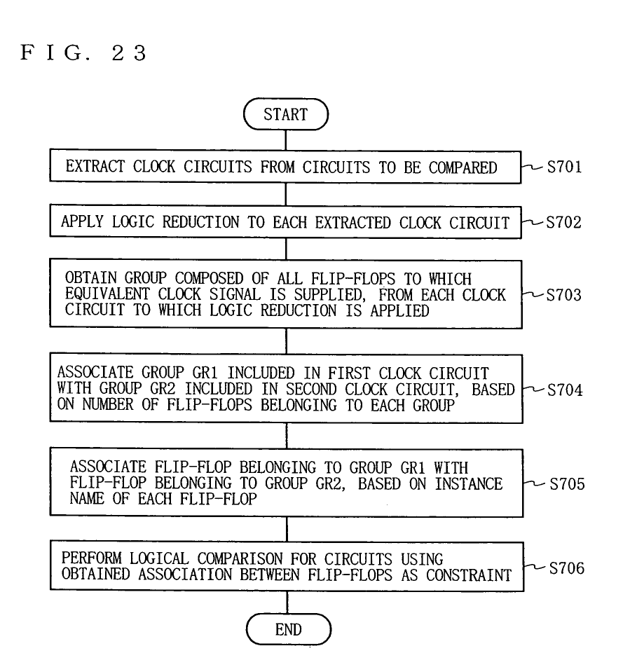

In the case where a plurality of constraint-imposed circuits are specified at step S601, a plurality of search results may be obtained at step S602 with regard to one circuit to be processed. For example, in the case where a circuit search is performed for the clock circuit as shown in FIG. 20A after circuits as shown in FIGS. 21A and 21B are specified as a constraint-imposed circuit, two search results are obtained as shown in FIG. 21C. Specifically, a partial circuit H1 composed of the flip-flop G2 and the NOR gate G3 corresponds to the circuit as shown in FIG. 21A, and a partial circuit H2 composed of the NOR gates G3 and G4 corresponds to the circuit as shown in FIG. 21B.

Thus, in the case where a plurality of constraint-imposed circuits are specified at step S601, any of the following methods may be used for associating the constraint-imposed circuit with a partial circuit at the time of circuit search at step S602. For example, the constraint-imposed circuit which first coincides with a partial circuit at the time of circuit search may be associated with the partial circuit. Alternatively, the constraint-imposed circuit which last coincides with a partial circuit at the time of circuit search may be associated with the partial circuit. Alternatively, all constraint-imposed circuits which coincide with respective partial circuits at the time of circuit search may be associated with the respective partial circuits. Alternatively, priorities are previously assigned to the constraint-imposed circuits, and the constraint-imposed circuit having the highest priority may be associated with a partial circuit.

As described above, based on the method for imposing the design constraint as shown in FIG. 19, a partial circuit to which a design constraint is to be imposed is automatically searched, and the design constraint is imposed on the partial circuit, whereby it is possible to reduce mistakes in imposing a design constraint and the number of steps required to impose the design constraint.

Next, the method for verifying the design constraint having the same feature of the method for imposing the design constraint as shown in FIG. 19 will be described. FIG. 22 is a flowchart showing the method for verifying a design constraint according to the present embodiment. A process as shown in FIG. 22 is performed for a circuit on which a design constraint is imposed and whose logic level design has been completed.

In the process as shown in FIG. 22, as is the case with steps S601 and S602 as shown in FIG. 19, a structure of a constraint-imposed circuit and a design constraint to be imposed are specified (step S621), and the specified constraint-imposed circuit is searched from the circuit to be processed (step S622). Next, it is determined whether or not the design constraint specified at step S621 is imposed on the circuit obtained at step S622 (step S623). Next, the determination results obtained at step S623 are outputted to a file or the screen (step S624). Typically, in the case where the specified design constraint is not imposed on the obtained circuit, information necessary for identifying the circuit (e.g., a name of a logic element) is outputted at step S624.

As described above, based on the method for verifying the design constraint as shown in FIG. 22, a partial circuit on which a design constraint is to be imposed is automatically searched, and determination is performed whether or not the design constraint is appropriately imposed on the partial circuit, whereby it is possible to reduce mistakes in imposing a design constraint and the number of steps required to impose the design constraint.

(Seventh Embodiment)

In a seventh embodiment of the present invention, a circuit comparison method using design data of a semiconductor integrated circuit will be described. FIG. 23 is a flowchart showing a circuit comparison method (first method) according to the present embodiment. A process as shown in FIG. 23 is performed for two circuits (hereinafter, referred to as first and second circuits) realizing substantially the same logic. For example, the second circuit is obtained by making a slight modification to the first circuit.

In the process as shown in FIG. 23, a clock circuit composed of logic elements and wires located on a clock path is extracted from each of the first and second circuits (step S701). Hereinafter, the clock circuits extracted from the first and second circuits are referred to as first and second clock circuits, respectively. Next, logic reduction is applied to each clock circuit extracted at step S701 (step S702). Next, a group composed of all flip-flops to which a logically equivalent clock signal is supplied is obtained with respect to each clock circuit obtained as a result of logic reduction (step S703). Specifically, flip-flops included in the first clock circuit are divided into groups so that flip-flops to which a logically equivalent clock signal is supplied belong to the same group. The same processing is performed for the second clock circuit.

Next, a group included in the first clock circuit is associated with a group included in the second clock circuit based on the number of flip-flops belonging to each group (step S704). In this case, the groups including roughly the same number of flip-flops are associated with each other.

Next, a flip-flop belonging to the group included in the first clock circuit is associated with a flip-flop belonging to the group which is associated with the above group and is included in the second clock circuit, based on an instance name of each flip-flop (step S705). At step S705, flip-flops may be associated with each other only if more than half of the instance names of the flip-flops belonging to the group included in the first clock circuit coincide with the instance names of the flip-flops belonging to the group included in the second clock circuit, for example.

Next, logical comparison is performed for the first and second circuits using the association between flip-flops obtained at step S705 as a constraint (step S706). Typically, step S706 is executed using a logical comparison tool.

Note that, in the case where only an inadequate association is established between the flip-flops at step S705 (for example, less than half of the instance names of the flip-flops belonging to the group included in the first clock circuit coincide with the instance names of the flip-flops belonging to the group included in the second clock circuit), an association is re-established between the groups at step S704.

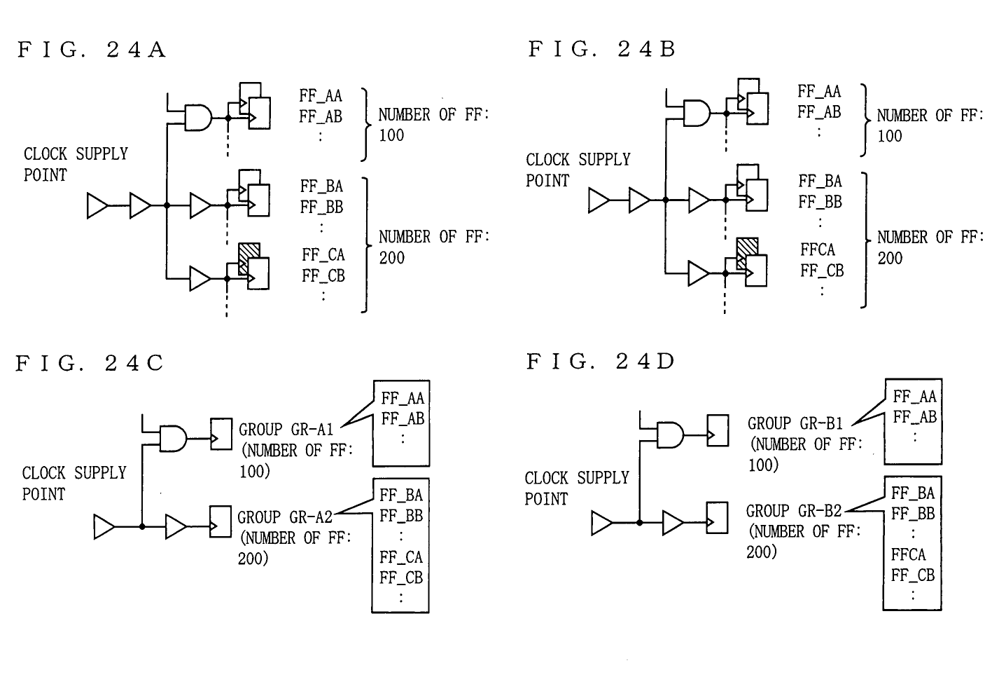

With reference to FIGS. 24A to 24D, one example of execution of the circuit comparison method as shown in FIG. 23 will be described. Assume that a first clock circuit as shown in FIG. 24A is extracted from a first circuit, and a second clock circuit as shown in FIG. 24B is extracted from a second circuit by executing step S701. Also, assume that the first clock circuit and the second clock circuit are different from each other only in that the instance names of a portion of the flip-flops included in the first and second clock circuits are different. For example, assume that a flip-flop (indicated by hatching) is provided with an instance name FF_CA in the first clock circuit, and the same flip-flop is provided with an instance name FFCA in the second clock circuit.

By executing steps S702 and S703 to the first and second clock circuits, the results as shown in FIGS. 24C and 24D are obtained, respectively. That is, in the case where the flip-flops included in the first clock circuit to which logic reduction is applied are divided into groups so that the flip-flops to which a logically equivalent clock signal is supplied belong to the same group, a group GR-A1 including one hundred flip-flops and a group GR-A2 including two hundred flip-flops are obtained. In the case where the same processing is performed for the second clock circuit to which logic reduction is applied, a group GR-B1 including one hundred flip-flops and a group GR-B2 including two hundred flip-flops are obtained.

At step S704, groups including roughly the same number of flip-flops are associated with each other. In FIGS. 24A to 24D, one hundred flip-flops, two hundred flip-flops, one hundred flip-flops, and two hundred flop-flips belong to the groups GR-A1, GR-A2, GR-B1, and GR-B2, respectively. Thus, the group GR-A1 is associated with the group GR-BL, and the group GR-A2 is associated with the group GR-B2.

Next, at step S705, based on the instance name of each flip-flop, the flip-flops belonging to the group GR-A1 are associated with the flip-flops belonging to the group GR-B1, and the flip-flops belonging to the group GR-A2 are associated with the flip-flops belonging to the group GR-B2. Next, at step S706, logical comparison is performed for the first and second circuits using the obtained association between the flip-flops as a constraint.

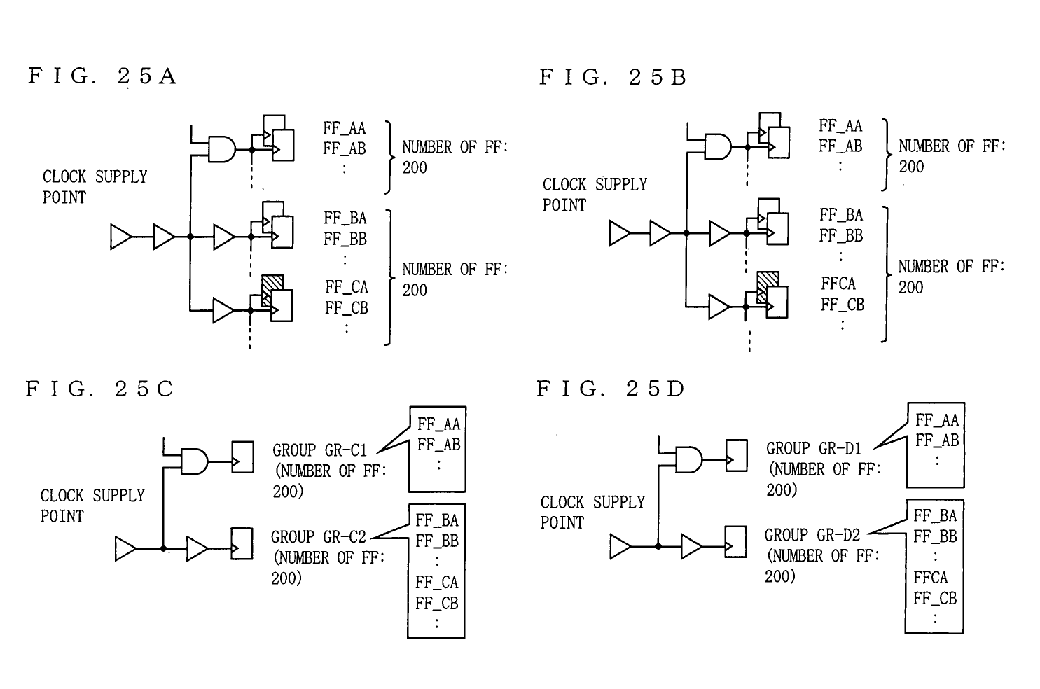

FIGS. 25A to 25D are illustrations showing another example of execution of the circuit comparison method. FIGS. 25A to 25D are similar to FIGS. 24A to 24D. In this example, in the case where steps S702 and S703 are executed to a first clock circuit (FIG. 25A) and a second clock circuit (FIG. 25B), the results as shown in FIGS. 25C and 25D are obtained. Assume that two hundred flip-flops belong to groups GR-C1, GR-C2, GR-D1, and GR-D2, respectively. In this case, in the case where an association is established between the groups at step S703, there may be two association patterns: “the group GR-CL is associated with the group GR-D1 and the group GR-C2 is associated with the group GR-D2”; and “the group GR-C1 is associated with the group GR-D2 and the group GR-C2 is associated with the group GR-D1”. As such, in the case where a plurality of associations can be established at step S704 due to a plurality of groups whose numbers of flip-flops are the same or roughly the same, steps S705 and S706 may be performed with respect to each association, thereby using the best result among the results obtained at step S706 as a final logical comparison result.

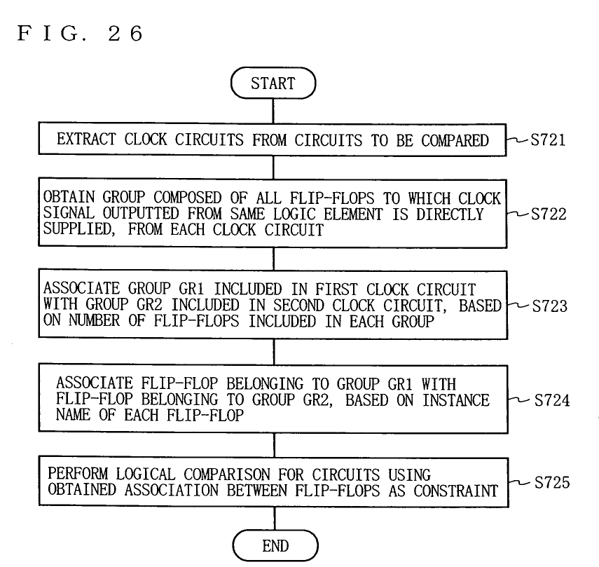

FIG. 26 is a flowchart showing a circuit comparison method (second method) according to the present embodiment. As is the case with the process as shown in FIG. 23, a process as shown in FIG. 26 is performed for the two circuits realizing substantially the same logic. As is the case with the process as shown in FIG. 23, in the process as shown in FIG. 26, a clock circuit composed of logic elements and wires located on a clock path is extracted from each of the first and second circuits (step S721).

Next, a group composed of all flip-flops to which a clock signal outputted from the same logic element is directly supplied is obtained from each clock circuit extracted at step S721 (step S722). In other words, the flip-flops included in the first clock circuit are divided so that the flip-flops having the same logic element at the last stage of the clock path belong to the same group. The same processing is performed for the second clock circuit. Note that, in the process as shown in FIG. 26, a process for applying logic reduction to each clock circuit is not performed before step S722.

Then, the same process as steps S704 to S706 as shown in FIG. 23 is performed using the groups obtained at step S722. That is, the group included in the first clock circuit is associated with the group included in the second clock circuit based on the number of flip-flops belonging to each group (step S723). Next, a flip-flop belonging to the group included in the first clock circuit is associated with a flip-flop belonging to the group which is associated with the above group and is included in the second clock circuit, based on the instance name of each flip-flop (step S724). Then, logical comparison is performed for the first and second circuits using the obtained association as a constraint (step S725).

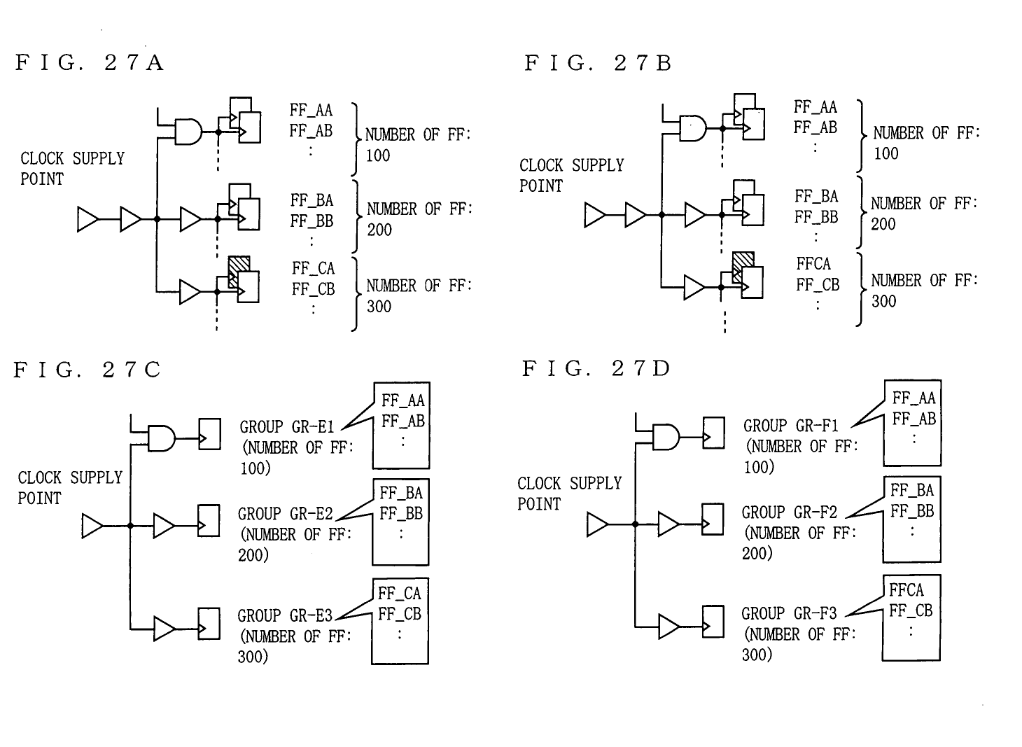

With reference to FIGS. 27A to 27D, one example of execution of the circuit comparison method as shown in FIG. 26 will be described. When a clock circuit is extracted from the circuit to be compared at step S721, a first clock circuit as shown in FIG. 27A is extracted from the first circuit, and a second clock circuit as shown in FIG. 27B is extracted from the second circuit. When step S722 is executed to the first and second clock circuits, the results as shown in FIGS. 27C and 27D are obtained. That is, in the case where the flip-flops included in the first clock circuit to which logic reduction is applied are divided so that the flip-flops having the same logic element at the last stage of the clock path belong to the same group, a group GR-E1 including one hundred flip-flops, a group GR-E2 including two hundred flip-flops, and a group GR-E3 including three hundred flip-flops are obtained. In the case where the same processing is performed for the second clock circuit to which logic reduction is applied, a group GR-F1 including one hundred flip-flops, a group GR-F2 including two hundred flip-flops, and a group GR-F3 including three hundred flip-flops are obtained. Note that, in the process as shown in FIG. 26, the group GR-E2 and the group GR-E3 are treated as different groups since different logic elements are located at the last stage of the clock paths on which the flip-flop belonging to the group GR-E2 and the flip-flop belonging to the group GR-E3 are located, respectively. Similarly, the group GR-F2 and the group GR-F3 are treated as different groups.

The numbers of flip-flops belonging to the groups GR-E1, GR-E2, GR-E3, GR-FL, GR-F2, and GR-F3 are one hundred, two hundred, three hundred, one hundred, two hundred, and three hundred, respectively. Thus, at step S723, the group GR-E1 is associated with the group GR-F1, the group GR-E2 is associated with the group GR-F2, and the group GR-E3 is associated with the group GR-F3. Next, at step S724, based on the instance name of each flip-flop, a flip-flop belonging to the group GR-E1 is associated with a flip-flop belonging to the group GR-F1, a flip-flop belonging to the group GR-E2 is associated with a flip-flop belonging to the group GR-F2, and a flip-flop belonging to the group GR-E3 is associated with a flip-flop belonging to the group GR-F3. Next, at step S725, logical comparison is performed for the first and second circuits using the obtained association between the flip-flops as a constraint.

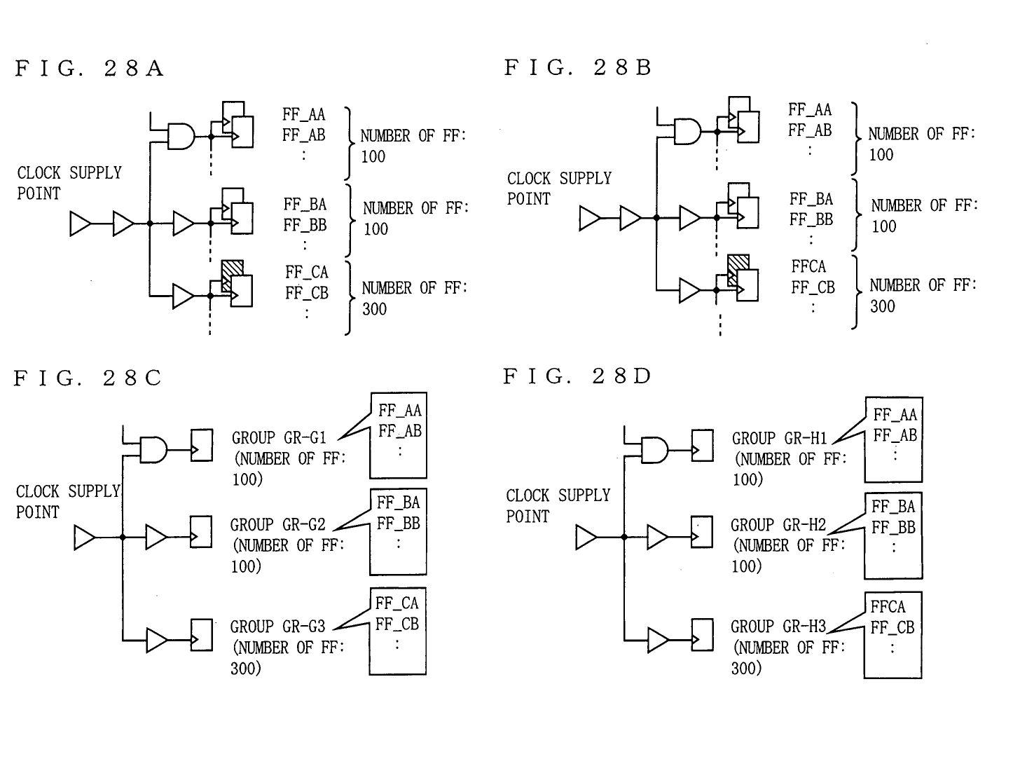

FIGS. 28A to 28D are illustrations showing another example of execution of the circuit comparison method. FIGS. 28A to 28D are similar to FIGS. 27A to 27D. In this example, when step S722 is executed to a first clock circuit (FIG. 28A) and a second clock circuit (FIG. 28B), the results as shown in FIGS. 28C and 28D are obtained. The numbers of flip-flops belonging to groups GR-G1, GR-G2, GR-G3, GR-H1, GR-H2, and GR-H3 are one hundred, one hundred, three hundred, one hundred, one hundred, and three hundred, respectively. In this case, in the case where an association is established between the groups at step S723, there may be two association patterns: “the group GR-G1 is associated with the group GR-H1, the group GR-G2 is associated with the group GR-H2, and the group GR-G3 is associated with the group GR-H3”; and “the group GR-G1 is associated with the group GR-H2, the group GR-G2 is associated with the group GR-H1, and the group GR-G3 is associated with the group GR-H3”. As such, in the case where a plurality of associations can be established at step S723 due to a plurality of groups whose numbers of flip-flops are the same or roughly the same, steps S724 and S725 may be performed with respect to each association, thereby using the best result among the results obtained at step S725 as a final logical comparison result.

As described above, based on the circuit comparison method according to the present embodiment, it is possible to efficiently compare circuits even if the circuits do not include exactly the same number of flip-flops and a portion of flip-flops included in the circuits have different instance names.

(Eighth Embodiment)

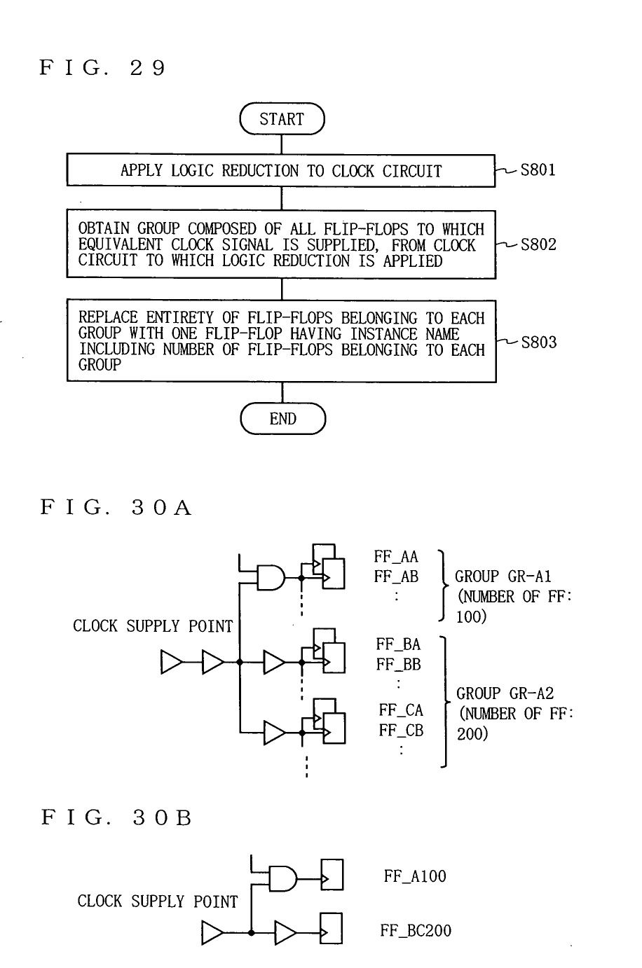

In an eighth embodiment of the present invention, a method for obtaining simplified design data of a clock circuit will be described. FIG. 29 is a flowchart showing a method (first method) for generating design data of a clock circuit according to the present embodiment. A process as shown in FIG. 29 is performed for a clock circuit composed of logic elements and wires located on a plurality of clock paths. A clock circuit to be displayed is specified by the method as described in the first embodiment, for example.

In the process as shown in FIG. 29, logic reduction is first applied to the clock circuit to be processed (step S801). Next, a group composed of all flip-flops to which a logically equivalent clock signal is supplied is obtained from the clock circuit to which logic reduction is applied (step S802). Steps S801 and S802 are identical to steps S702 and S703 as shown in FIG. 23. Next, the entirety of the flip-flops belonging to each group is replaced with one flip-flop having an instance name including the number of flip-flops belonging to each group (step S803). As a result, simplified design data of the circuit is generated.

The details of a case in which simplified design data of a clock circuit as shown in FIG. 30A is obtained by the method as shown in FIG. 29 will be described below. The circuit as shown in FIG. 30A is identical to the circuit as shown in FIG. 24A. When steps S801 and S802 are executed to the circuit as shown in FIG. 30A, the group GR-A1 including one hundred flip-flops and the group GR-A2 including two hundred flip-flops are obtained. Next, at step S803, the entirety of the flip-flops belonging to the group GR-A1 is replaced with one flip-flop having an instance name (in this case, FF_A100) including the number of flip-flops (100) belonging to the group GR-A1, and the entirety of the flip-flops belonging to the group GR-A2 is replaced with one flip-flop having an instance name (in this case, FF_BC200) including the number of flip-flops (200) belonging to the group GR-A2. As a result, simplified design data of the circuit as shown in FIG. 30A is generated (see FIG. 30B).

FIG. 31 is a flowchart showing a method (second method) for generating design data of a clock circuit according to the present embodiment. As is the case with the process as shown in FIG. 29, a process as shown in FIG. 31 is executed to a clock circuit composed of logic elements and wires located on a plurality of clock paths.

In the process as shown in FIG. 31, a group composed of all flip-flops to which a clock signal outputted from the same logic element is directly supplied is first obtained from a clock circuit to be processed (step S821). Next, the entirety of the flip-flops belonging to each group is replaced with one flip-flop having an instance name including the number of flip-flops belonging to each group (step S822). As a result, simplified design data of the clock circuit is generated. Note that step S821 and step S822 are identical to step S703 as shown in FIG. 23 and step S803 as shown in FIG. 29, respectively.

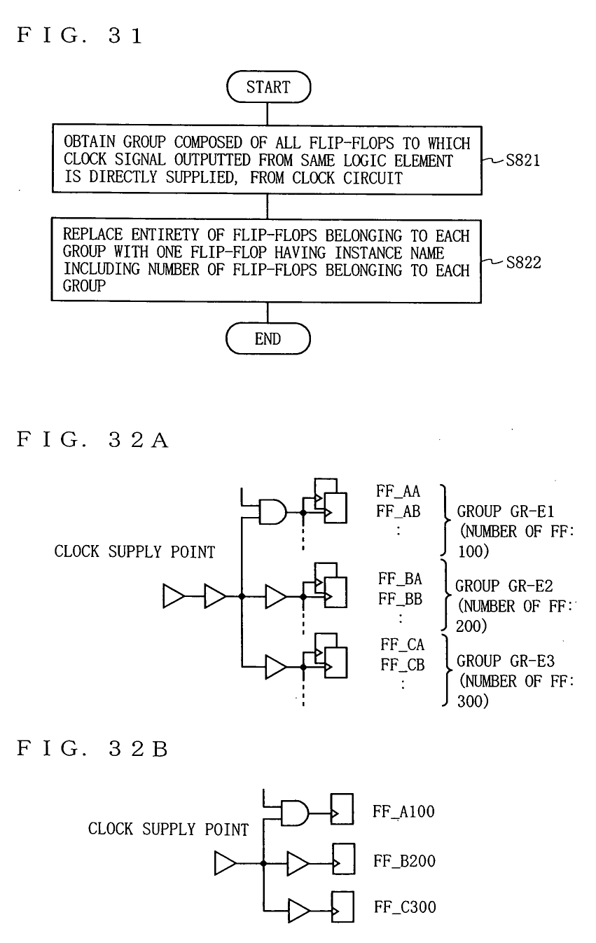

The details of a case in which simplified design data of a clock circuit as shown in FIG. 32A is obtained by the method as shown in FIG. 31 will be described below. The circuit as shown in FIG. 32A is identical to the circuit as shown in FIG. 27A. When step S821 is executed to the circuit as shown in FIG. 32A, the group GR-E1 including one hundred flip-flops, the group GR-E2 including two hundred flip-flops, and the group GR-E3 including three hundred flip-flops are obtained. Next, at step S822, the entirety of the flip-flops belonging to the group GR-E1 is replaced with one flip-flop having an instance name (in this case, FF_A100) including the number of flip-flops (100) belonging to the group GR-E1, the entirety of the flip-flops belonging to the group GR-E2 is replaced with one flip-flop having an instance name (in this case, FF_B200) including the number of flip-flops (200) belonging to the group GR-E2, and the entirety of the flip-flops belonging to the group GR-E3 is replaced with one flip-flop having an instance name (in this case, FF_C300) including the number of flip-flops (300) belonging to the group GR-E3. As a result, simplified design data of the clock circuit as shown in FIG. 32A is generated (see FIG. 32B).

As described above, based on the design data generation method according to the present embodiment, it is possible to generate simplified design data reflecting the number of flip-flops. Thus, it is possible to perform circuit comparison, etc., with ease using the generated design data.

The method of the present invention for processing design data of a semiconductor integrated circuit allows the designer to understand logic with ease, for example, whereby it is possible to use this method in an EDA system, etc., used for designing the semiconductor integrated circuit.

While the invention has been described in detail, the foregoing description is in all aspects illustrative and not restrictive. It is understood that numerous other modifications and variations can be devised without departing from the scope of the invention.

1. A method for displaying a clock circuit using design data of a semiconductor integrated circuit, comprising the steps of:
obtaining a circuit for display by removing a buffer and an inverter without changing logic from a clock circuit composed of logic elements and wires located on a clock path; and
displaying the obtained circuit for display.

2. The method according to claim 1, wherein the step of obtaining the circuit for display removes, from the clock circuit, all buffers which do not change logic and, when the clock path is divided at a branch point of wiring, all pairs of inverters located on each divided clock path.

3. The method according to claim 1, wherein
the step of obtaining the circuit for display includes the steps of:
copying a logic element located on a plurality of clock paths and adding the duplicate logic element to the clock circuit so that the clock paths are independent of each other;
removing, from the clock circuit to which the logic element is added, all buffers which do not change logic and all pairs of inverters located between logic elements other than the buffers which do not change logic; and
removing, from the clock circuit from which the buffers and the pairs of inverters are removed, redundant partial circuits, if any, realizing a same logic and being located on a plurality of clock paths so that each clock path has a common section.

4. A method for displaying a clock circuit using design data of a semiconductor integrated circuit, comprising the steps of:
specifying a display color of a wire on which one clock signal is propagated and a display color of a wire on which a plurality of clock signals are propagated; and
displaying a clock circuit composed of logic elements and wires located on a clock path, wherein
the step of displaying the clock circuit differentiates between the wire on which one clock signal is propagated and the wire on which a plurality of clock signals are propagated, and displays each wire using the specified display color.

5. A method for displaying a clock circuit using design data of a semiconductor integrated circuit, comprising the steps of:
specifying an association between a logic element located on a first clock path and a logic element located on a second clock path; and
displaying a clock circuit composed of logic elements and wires with respect to each of the first and second clock paths, wherein
the step of displaying the clock circuit displays the clock circuit so that the specified logic elements are aligned in a line horizontally or vertically across a screen.

6. A method for displaying a circuit using design data of a semiconductor integrated circuit, comprising the steps of:
specifying a structure of a partial circuit which is composed of a plurality of logic elements and at least one wire and is to be displayed as one component;
searching the partial circuit from a circuit to be displayed; and
displaying the circuit to be displayed while displaying the partial circuit obtained as a result of searching as one component.

7. The method according to claim 6, wherein the partial circuit is specified using an instance of a logic element.

8. The method according to claim 6, wherein the partial circuit is specified using a type of a logic element.

9. A method for displaying a circuit using design data of a semiconductor integrated circuit, comprising the steps of:
obtaining attribute information of a wire from design data including a layout result of a circuit to be displayed; and
displaying the circuit to be displayed while displaying each wire in a mode corresponding to the obtained attribute information.

10. A method for imposing a design constraint on design data of a semiconductor integrated circuit, comprising the steps of:
specifying a structure of a partial circuit including a plurality of logic elements and at least one wire, and a design constraint to be imposed on the partial circuit;
searching the partial circuit from a circuit to be processed; and
imposing the specified design constraint on the partial circuit obtained as a result of searching.

11. A method for verifying a design constraint imposed on design data of a semiconductor integrated circuit, comprising the steps of:
specifying a structure of a partial circuit including a plurality of logic elements and at least one wire, and a design constraint to be imposed on the partial circuit;
searching the partial circuit from a circuit to be processed;
determining whether or not the specified design constraint is imposed on the partial circuit obtained as a result of searching; and
outputting the determination results.

12. A method for comparing circuits using design data of a semiconductor integrated circuit, comprising the steps of:
extracting first and second clock circuits, each of which is composed of logic elements and wires located on a clock path, from respective first and second circuits to be compared with each other;
obtaining a group of storage elements to which a logically equivalent clock signal is supplied, from the respective first and second clock circuits;
associating a first group included in the first clock circuit with a second group included in the second clock circuit based on a number of storage elements belonging to each group;
associating a storage element belonging to the first group included in the first clock circuit with a storage element belonging to the second group which is associated with the first group and is included in the second clock circuit based on an instance name of each storage element; and
performing logical comparison for the first and second circuits using the obtained association between the storage elements as a constraint.

13. The method according to claim 12, further comprising a step of applying logic reduction to the first and second clock circuits, wherein
the step of obtaining a group obtains a group composed of all storage elements to which a logically equivalent clock signal is supplied, from the respective first and second clock circuits to which logic reduction is applied.

14. The method according to claim 12, wherein the step of obtaining a group obtains a group composed of all storage elements to which a clock signal outputted from a same logic element is directly supplied, from the respective first and second clock circuits.

15. A method for obtaining simplified design data of a clock circuit based on design data of a semiconductor integrated circuit, comprising the steps of:
obtaining a group of storage elements to which a logically equivalent clock signal is supplied, from a clock circuit composed of logic elements and wires located on a clock path; and
replacing an entirety of storage elements belonging to each group with one storage element having an instance name including a number of storage elements belonging to each group.

16. The method according to claim 15, further comprising a step of applying logic reduction to the clock circuit, wherein
the step of obtaining a group obtains a group composed of all storage elements to which a logically equivalent clock signal is supplied, from the clock circuit to which logic reduction is applied.

17. The method according to claim 15, wherein the step of obtaining a group obtains a group composed of all storage elements to which a clock signal outputted from a same logic element is directly supplied, from the clock circuit.
